(19) United States
(12) Patent Application Publication
(10) Pub. No.: US 2009/0002741 A1
(43) Pub. Date: Jan. 1, 2009

(54) INFORMATION PROCESSING APPARATUS, INFORMATION PROCESSING METHOD, RECORDING MEDIUM, AND PROGRAM

(75) Inventor: Shuji Ozawa, Hino-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/145,071

(22) Filed: Jun. 24, 2008

(30) Foreign Application Priority Data
Jun. 26, 2007 (JP) 2007-167932

(51) Int. Cl. G06F 3/12

(52) U.S. Cl. 358/1.13

(57) ABSTRACT

An information processing apparatus configured to edit data including an object used for forming an image includes a determination unit configured to determine whether the object can be normally output with a resource used for forming a specific image before forming an image of the object, and a generation unit configured to generate data that restricts editing of the object that is determined to be normally outputable by the determination unit and generate data that does not restrict the editing of the object that is determined not to be normally outputable by the determination unit.

### BACKGROUND OF THE INVENTION

1. Field of the Invention

The present invention relates to an information processing apparatus configured to process an object used for forming an image.

2. Description of the Related Art

Conventionally, a service has been offered for printing an electronic document having a format such as portable document format (PDF), postscript (PS), or scalable vector graphics (SVG) received from a user.

In a conventional service like this, an operator performs a preflight check on an electronic document received via a print system. Then, if the operator verifies that it is appropriate to print the electronic document with current print settings, the operator prints the electronic document.

Here, the “preflight check” refers to checking contents of an electronic document before performing actual printing to prevent a suspension of an operation due to shortage of resources after having started actual printing. In this case, the operator performs the preflight check on the image forming apparatus.

Items to be checked primarily include items related to the resource that is necessary for printing the electronic document. More specifically, items to be checked primarily include types of fonts, information about whether the fonts have been embedded, a name of a color profile, and a resolution of image data included in the electronic document.

In some cases, a print product desired by a user may not be obtained even when a preflight check has been performed on a host computer which generates an electronic document before the electronic document is sent to the image forming apparatus and printed thereby. This is because a quality of a print product may vary due to the characteristics of the image forming apparatus.

For example, according to an environment in which an image forming apparatus is used, the color reproduction characteristic of the image forming apparatus may vary, for example, due to the temperature or the humidity variation at the time of printing. Furthermore, if an image forming apparatus does not originally have a capacity to reproduce a color desired by a user, the user may not obtain a print product having a desired quality. In order to address such a problem, a conventional method performs a preflight check on an image forming apparatus separately from a preflight check on a host computer.

In such a conventional method, it is necessary for the operator to perform a preflight check on the host computer and then to perform another preflight check on the image forming apparatus as a last stage of preprint processing to reedit (correct) problems inherent in a document or a portion thereof.

Such a conventional method, in the above-described processing, uses a work flow in which the image forming apparatus notifies a result of the preflight check to the operator and the operator sends to the image forming apparatus the document whose invalid content has been appropriately reedited (corrected). During this processing, the operator can perform a test printing.

The document thus sent from an information processing apparatus to the image forming apparatus is then subjected to another preflight check. In this preflight check, a portion that has been determined not to include an invalid drawing description in the previous preflight check performed on the image forming apparatus may be determined to include an invalid drawing description. This may arise if the operator has made an error in editing the document. In this case, the result of the preflight check is notified to the operator again, and then the operator is prompted to reedit the portion determined to include the invalid drawing description.

This work flow may be repeatedly performed in the conventional method. Accordingly, the time taken for the processing by the operator may become long which may degrade the operation efficiency. A throughput of an image forming apparatus is generally lower than that of a host computer. Accordingly, the conventional method has a problem such that a very long time may be taken to perform a plurality of image forming operations for preflight checks and test printing.

Furthermore, in a conventional system that performs a print processing service, if an error in the content edited by the operator is overlooked, a print product different from what a user desired may be provided to the user. In this case, a serious user complaint may arise.

Japanese Patent Application Laid-Open No. 2004-252248 discusses a system which generates print data used for printing an original document based on the original document data and also generates proofreading data which is generated by converting the print data into low resolution and a preflight check report of the print data. Further, Japanese Laid-Open Patent Application Laid-Open No. 2004-252248 discusses the system which sends the data for proofreading data and the preflight check report to a host computer via a file transmission server or an Internet gateway server.

### SUMMARY OF THE INVENTION

The present invention is directed to an image forming system including an information processing apparatus and an image forming apparatus and configured to appropriately and efficiently correct a content of an original document to be printed.

According to an aspect of the present invention, an information processing apparatus configured to edit data including an object used for forming an image includes a determination unit configured to determine whether the object can be normally output with a resource used for forming a specific image before forming an image of the object, and a generation unit configured to generate data that restricts editing of the object that is determined to be normally outputable by the determination unit and generate data that does not restrict the editing of the object that is determined not to be normally outputable by the determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a portion of the specification, illustrate exemplary embodiments, features, and aspects of the invention and, together with the description, serve to explain the principles of the present invention.

FIG. 1A illustrates an example of an image forming system to which an information processing apparatus can be applied according to a first exemplary embodiment of the present invention.

FIG. 1B is a block diagram illustrating an exemplary hardware configuration of the image forming system illustrated in FIG. 1A.

FIG. 2 illustrates an example of processing for generating an electronic document performed by an electronic document generation module (DM) illustrated in FIG. 1A.

FIG. 3 illustrates an example of a format of an electronic document that can be processed by an image forming apparatus according to the first exemplary embodiment of the present invention.

FIG. 4 is a flow chart illustrating an example of data processing performed by the image forming apparatus according to the first exemplary embodiment of the present invention.

FIG. 5 illustrates an example of a user interface displayed on a liquid crystal display unit of the image forming apparatus illustrated in FIG. 1.

FIG. 6 illustrates an example of processing for generating an electronic document performed with the electronic document generation module (DM) illustrated in FIG. 1.

FIG. 7 is a flow chart illustrating an example of data processing performed by the image forming apparatus according to the first exemplary embodiment of the present invention.

FIG. 8A illustrates an example of a user interface that can be displayed on the image forming apparatus according to the first exemplary embodiment of the present invention.

FIG. 8B illustrates an example of a user interface that can be displayed on the image forming apparatus according to the first exemplary embodiment of the present invention.

FIG. 8C illustrates an example of a user interface that can be displayed on the image forming apparatus according to the first exemplary embodiment of the present invention.

FIG. 9 illustrates an example of a format of an electronic document edited on the image forming apparatus according to the first exemplary embodiment of the present invention.

FIG. 10 is a flow chart illustrating an example of data processing performed by the information processing apparatus according to the first exemplary embodiment of the present invention.

FIG. 11A illustrates an example of a user interface displayed on the information processing apparatus according to the first exemplary embodiment of the present invention.

FIG. 11B illustrates an example of a user interface displayed on the information processing apparatus according to the first exemplary embodiment of the present invention.

FIG. 11C illustrates an example of a user interface displayed on the information processing apparatus according to the first exemplary embodiment of the present invention.

FIG. 12 illustrates an example of preflight check processing performed on the image forming apparatus according to the first exemplary embodiment of the present invention.

FIG. 13 illustrates an example of an electronic document that can be processed by an information processing apparatus according to a second exemplary embodiment of the present invention.

FIG. 14 illustrates an example of processing an object performed by the information processing apparatus according to the second exemplary embodiment of the present invention.

FIG. 15 illustrates an example of processing for editing an electronic document performed by an information processing apparatus according to a third exemplary embodiment of the present invention.

FIG. 16 illustrates an example of a format of an electronic document illustrated in FIG. 15.

FIG. 17 illustrates an example of a memory map of a storage medium storing various data processing programs that can be read by the image forming apparatus according to the exemplary embodiments of the present invention.

FIG. 18 illustrates an example of a memory map of a storage medium storing various data processing programs that can be read by the information processing apparatus according to the exemplary embodiments of the present invention.

### DETAILED DESCRIPTION OF THE EMBODIMENTS

Various exemplary embodiments, features, and aspects of the present invention will be described in detail below with reference to the drawings. It is noted that the relative arrangement of the components, the numerical expressions, and numerical values set forth in these embodiments are not intended to limit the scope of the present invention.

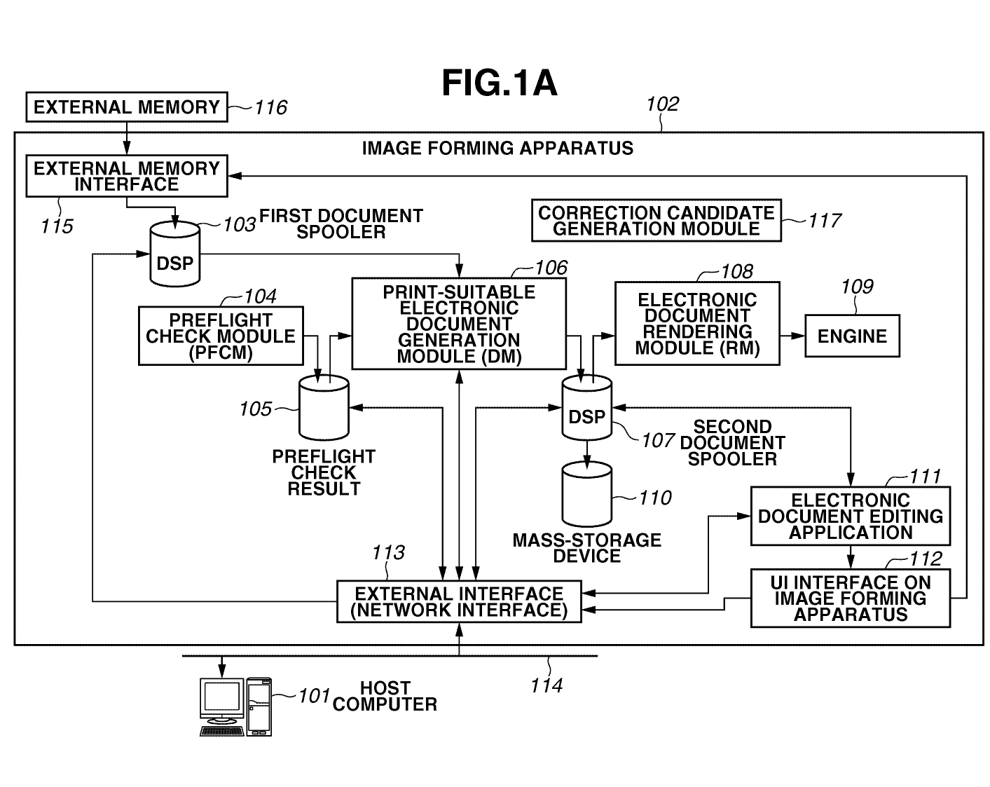

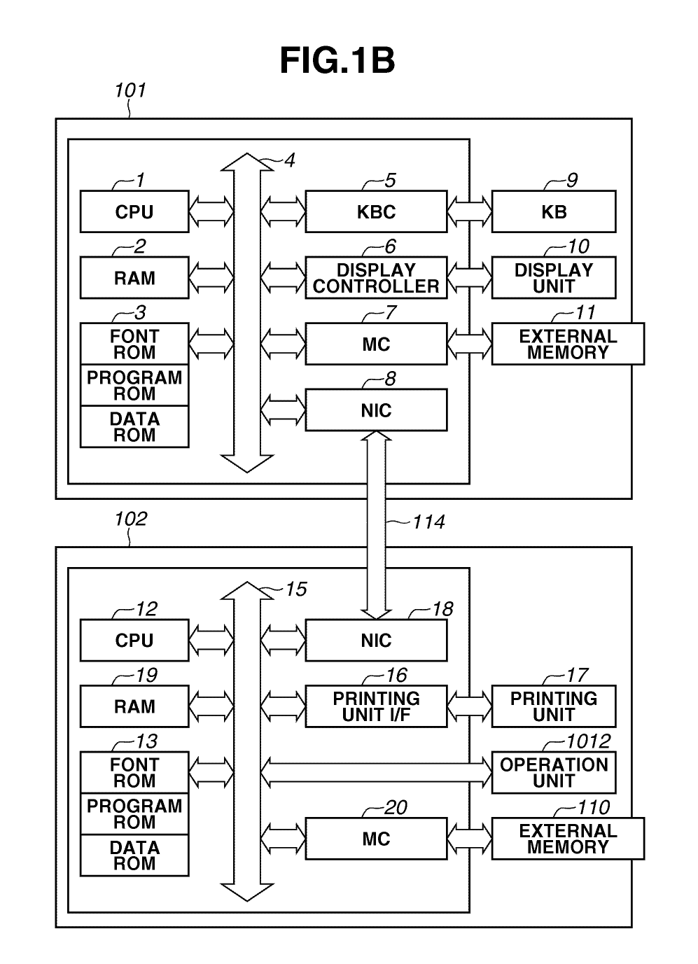

FIG. 1A illustrates an example of an image forming system to which an information processing apparatus according to a first exemplary embodiment of the present invention can be applied. FIG. 1A illustrates an exemplary hardware configuration of an image forming apparatus of the image forming system. Referring to FIG. 1, a host computer 101 can communicate with an image forming apparatus 102 via a network 114. The host computer 101 includes a controller unit, an input device, a display device, and an external storage device. Here, the controller unit of the host computer 101 includes a central processing unit (CPU), a read-only memory (ROM), and a random access memory (RAM). An operating system (OS) installed on the host computer 101 controls the execution of an application.

In FIG. 1A, an operator operates the host computer 101 to send an electronic document to be preflight-checked or a print request to the image forming apparatus 102 which is connected to the host computer 101 via the network 114. A format of an electronic document can include PDF, PS, and SVG.

In the case where an electronic document sent from the host computer 101 is the electronic document to be preflight-checked, an external interface (I/F) 113 of the image forming apparatus 102 receives the electronic document sent from the host computer 101. The image forming apparatus 102 stores the received electronic document on a first document spooler (DSP) 103.

On the other hand, in the case where the image forming apparatus 102 receives a print request via a printer driver of the host computer 101, the external interface 113 cuts off the print request to issue an instruction for starting rendering to an electronic document rendering module (RM) 108.

A preflight check module (PFCM) 104 acquires the electronic document from the first document spooler 103 and stores a result of a preflight check (a PF result) 105 performed on the electronic document. A “PF” refers to a function for determining whether the electronic document acquired from the host computer 101 can be normally output with the resource of the image forming apparatus 102 before forming an image of the electronic document.

A print-suitable electronic document generation module (DM) 106 stores a print-suitable electronic document generated based on the electronic document stored in the first DSP 103 and the PF result 105, in a second DSP 107. At this time, a portion of the electronic document that is determined to be normally printable in the preflight check and a portion of the electronic document that is determined to be normally unprintable in the preflight check are stored as mutually different electronic documents.

Then, authentication information is added to the portion of the electronic document that is determined to be normally printable in the preflight check. After the authentication information is added thereto, the electronic document having the authentication information cannot be edited without performing authentication processing.

The second DSP 107 is connected to an external memory 110 and can store a plurality of electronic documents. In addition, an electronic document for integrating the above-described two electronic documents is generated and stored in the second DSP 107. The three electronic documents generated in this manner are associated with one another, for example, the three electronic documents can have the same file name but different file extensions.

For example, the portion of the electronic document that is determined to be normally printable is named “AAA.pr1”, and the portion of the electronic document that is determined to be normally unprintable is named “AAA.pr2”. The electronic document for integrating the two electronic documents is named “AAA.pr0”.

Based on the above-described determination result, the present exemplary embodiment can generate a first electronic document to which an attribute of being normally printable as the electronic document is added, and a second electronic document to which an attribute of being normally unprintable as the electronic document is added. The portion “pr1” of the file name “AAA.pr1” indicates the attribute of being normally printable. The portion “pr2” of the file name “AAA.pr2” indicates the attribute of being normally unprintable.

After an electronic document suitable for printing is completely generated, the DM 106 sends a preflight check result and a password used for authentication processing to the host computer 101 via the external interface 113.

The operator can acquire the preflight check result and the electronic document stored in the second DSP 107 from the host computer 101 via the external interface 113 of the image forming apparatus 102 and the network 114 to reedit the acquired check result and electronic document. Furthermore, the operator can reedit the electronic document on the image forming apparatus 102 using a user interface (UI) 112 and an electronic document editing application 111 installed on the image forming apparatus 102. The electronic document editing application 111 performs editing processing and display processing on the electronic document.

When printing of the electronic document is instructed via the UI 112 of the host computer 101 or the image forming apparatus 102, the image forming apparatus 102 forms an image using the electronic document RM 108 and performs actual printing of the electronic document using an engine 109.

The DM 106 generates an electronic document so that the electronic document RM 108 can perform processing at a high speed. For example, in the case where a character in the electronic document sent from the operator has been described with a character code, the DM 106 forms an image of the character and stores the character image in the second DSP 107 as well as the character code. Thus, it is not necessary for the electronic document RM 108 to perform processing for forming a character image. Accordingly, the electronic document RM 108 can process an electronic document at a high speed.

The operator can store the electronic document in a removable external memory 116 such as a universal serial bus (USB) memory and connect the external memory 116 storing the electronic document to an external memory interface 115 of the image forming apparatus 102. The operator can perform a preflight check on the electronic document stored in the host computer 101 or the external memory 116, via the UI 112 of the image forming apparatus 102.

In the case where the operator performs an operation via the UI 112 of the image forming apparatus 102, the notification sent to the host computer 101 from the image forming apparatus 102 is displayed on the UI 112.

A correction candidate generation module 117 generates correction candidates selected by the user during a preflight check according to the present exemplary embodiment as animation objects or three-dimensional objects.

The correction candidate generation module 117 includes a correction candidate output function. If it is determined that an electronic document cannot be normally output with a resource of the image forming apparatus 102, then the correction candidate generation module 117 outputs correction candidates as image information to enable normal output of the electronic document. The processing performed by the correction candidate generation module 117 will be described in detail below.

Here, the “resource” includes a hardware resource and a software resource (such as the type of the font included in an electronic document, whether any font is embedded, a name of the color profile, and the resolution of image data). The hardware resource includes an optional device that executes a stapling function, a bookbinding function, or a two-sided printing function. The correction candidate generation module 117 can be provided in the host computer 101.

FIG. 1B illustrates an exemplary hardware configuration of the image forming system illustrated in FIG. 1A. Components illustrated in FIG. 1B similar to those illustrated in FIG. 1A are provided with the same numerals and symbols.

Referring to FIG. 1B, the host computer 101 includes a CPU 1, a RAM 2, and a ROM 3. The CPU 1 loads and executes a control program stored in the ROM 3 onto the RAM 2 to control the entire operation of devices in communication with one another via an internal bus 4. The CPU 1 loads an OS, a device driver, and an application stored in an external memory 11 onto the RAM 2 to perform data processing. In addition, the CPU 1 sends generated output information via the device driver to the image forming apparatus 102.

A keyboard controller (KBC) 5 can be operated by a user to process a key cord input via a keyboard (KB) 9. The KB 9 can include a USB port for connecting a pointing device such as a mouse to the host computer 101.

A display controller 6 performs processing for displaying data and information on a display unit 10 while controlling a video random access memory (VRAM). A memory controller (MC) 7 controls an access to the external memory 11.

A network controller (NIC) 8 is communicably connected to the image forming apparatus 102 via the network 114.

The image forming apparatus 102 includes a CPU 12, a ROM 13, and a RAM 19. The CPU 12 loads and executes a control program stored in the ROM 13 onto the RAM 19 to control the entire operation of devices in communication with one another via an internal bus 15.

A network controller (NIC) 18 is communicably connected to the host computer 101 via the network 114. A printing unit I/F 16 notifies the CPU 12 of an output of image data to a printing unit 17 and notification information received from a sensor included in the printing unit 17. A function that the printing unit 17 can execute may differ due to a system configuration of the image forming apparatus 102. As a specific example, a sheet post-processing function executed by the printing unit 17 differs according to an optional device connected to the image forming apparatus 102.

An operation unit 1012 includes a display device and a touch panel. The operation unit 1012 has a function for displaying various user interfaces such as an image forming condition setting screen and an electronic document editing screen.

A memory controller (MC) 20 has functions for loading an application stored in the external memory 110 onto the RAM 19 and storing the electronic document received from the host computer 101 in a box area. The MC 20 performs a user authentication on a request issued as to a box document or an electronic document, by publicly known processing. The application includes an electronic document generation module (DM).

Furthermore, the external memory 110 includes a module that performs a preflight check on an electronic document received from the host computer 101 and a module that generates an electronic document suitable for printing based on the received electronic document.

In the case where an electronic document is determined as normally unprintable by the engine 109 based on a result of a preflight check by the PFCM 104, the DM 106 generates a second electronic document. The external memory 110 causes the PFCM 104 to further perform a preflight check on the second electronic document.

In the case where an electronic document is determined as normally printable by the engine 109 based on a result of a preflight check by the PFCM 104, the external memory 110 updates a first electronic document stored in the external memory 110, which is generated by the DM 106.

As described above, in the present exemplary embodiment, the preflight check is repeated on the second electronic document that is determined to be normally unprintable. Thus, the data size of the second electronic document to be preflight checked is reduced every time a preflight check is performed. Consequently, the present exemplary embodiment improves the efficiency in performing preflight check. In the present exemplary embodiment, the preflight check is performed on the electronic document per page.

In addition, an application for editing the electronic document received from the host computer 101 is installed on the external memory 110. The application can perform specific editing processing on the electronic document. The specific editing processing includes resetting an image output condition set to the second electronic document which is determined to be normally unprintable to the electronic document received from the host computer 101.

By performing the specific editing processing using the application, the second electronic document can be corrected to be the first electronic document which is normally printable with the resource of the image forming apparatus 102. Here, items to be corrected are determined based on resource of the image forming apparatus 102 and the set image output condition.

Furthermore, the application executed by the CPU 12 includes a function for determining, when the user issues a request for editing the first electronic document, whether the requested editing can be permitted based on authentication information entered by the user. This function can prevent the user from reediting the normally printable first electronic document by mistake. In addition, the function can respond to the desire of the user to positively reedit the normally printable first electronic document.

In the present exemplary embodiment, the image forming apparatus 102 performs a preflight check on the electronic document sent from the host computer 101 and the user performs editing of the second electronic document on the image forming apparatus 102.

However, it is also useful to notify a result of the preflight check to the host computer 101. The host computer 101 generates the electronic document and edits the electronic document to be normally printable using the application installed on the host computer 101. That is, a system configured to perform document processing according to the present exemplary embodiment by operating the host computer 101 and the image forming apparatus 102 which cooperate with each other can be included in the scope of the present invention.

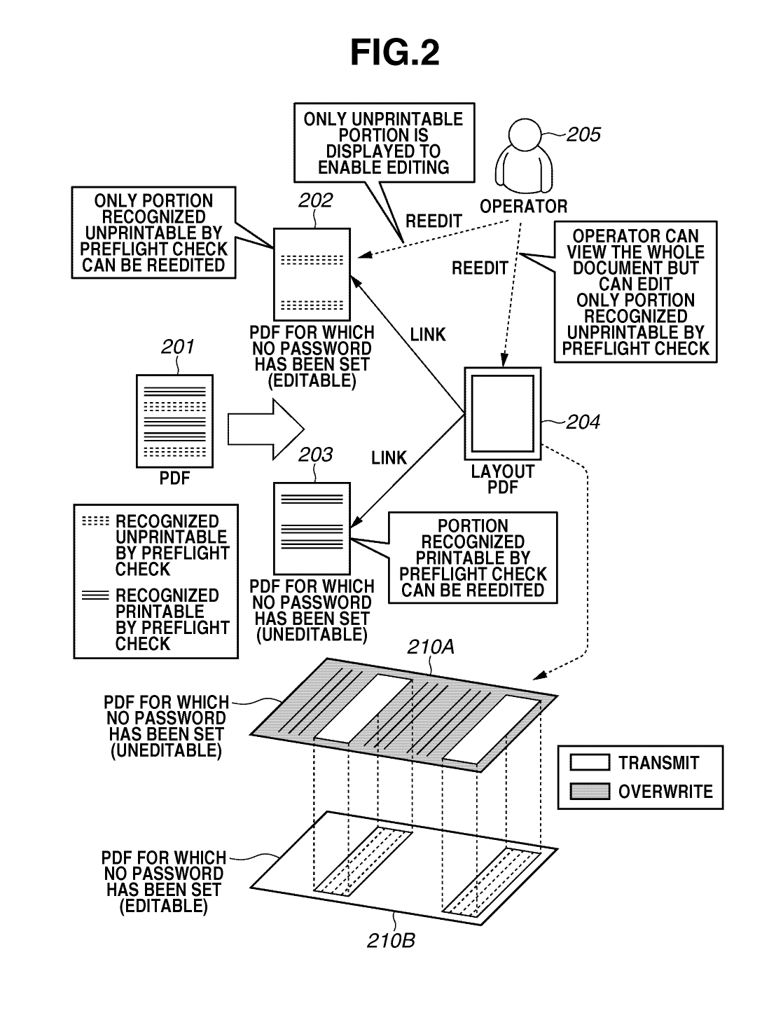

FIG. 2 illustrates an example of processing for generating an electronic document performed by the electronic document generation module (DM) 106 (FIG. 1A). In the present exemplary embodiment, an electronic document 201 is a PDF document. Now, the generation of the above-described three documents will be described.

Referring to FIG. 2, the DM 106 generates three electronic documents (EDOCs) after the preflight check of the electronic document 201.

An EDOC 203 which is a first electronic document generated by the DM 106 is a portion of the electronic document 201 that is determined to be normally printable in the preflight check. An EDOC 202 which is a second electronic document generated by the DM 106 is a portion of the electronic document 201 that is determined to be normally unprintable in the preflight check. An EDOC 204 is a third electronic document generated by the DM 106 for integrating the two EDOCs 203 and 202.

Thus, in reediting the electronic document 201 based on a result of the preflight check, an operator 205 can extract and reedit only the EDOC 202 which is a portion of the electronic document 201 that is determined to be normally unprintable.

In addition, according to the present exemplary embodiment, by using the generated EDOCs 203, 202, and 204, the operator 205 can reedit the EDOC 202 while viewing the electronic document 201 displayed on the screen including the EDOC 203, the portion determined to be normally printable. However, the operator 205 cannot reedit the EDOC 203. That is, the present exemplary embodiment restricts reediting of the EDOC 203, the portion determined to be normally printable.

That is, the CPU 12 controls the request for editing the first electronic document or the second electronic document using the application installed on the external memory 110 according to an attribute of the first electronic document or the second electronic document by control procedures described below.

The EDOC 204 which integrates the EDOC 202 and the EDOC 203 displays a portion 210A determined to be normally printable in the preflight check and a portion 210B determined to be normally unprintable in the preflight check as one EDOC.

Therefore, the user can view the EDOC 203 and the EDOC 202 as one EDOC (the EDOC 204) on the UI 112 without feeling unpleasant. More specifically, in the example in FIG. 1A, the EDOC 204 integratedly including the EDOC 203 and the EDOC 202 is displayed on a display device of the operation unit 1012 (FIG. 1B). The display device of the operation unit 1012 can display a color image, so that in the case of outputting a preflight check correction candidate as an image, the user can easily select the correction candidate by viewing a color image of the correction candidates displayed as animation objects or three-dimensional objects. The processing for selecting a correction candidate displayed as an animation object or a three-dimensional object will be described in more detail below.

Accordingly, the CPU 12 performs control so that the EDOC 204 integrates the portion determined to be normally unprintable and the portion determined to be normally printable in the preflight check and displays the portions as one EDOC. Thus, the EDOC 204 can be displayed on the UI 112 as one EDOC, without causing the operator 205 to feel unpleasant in viewing the same.

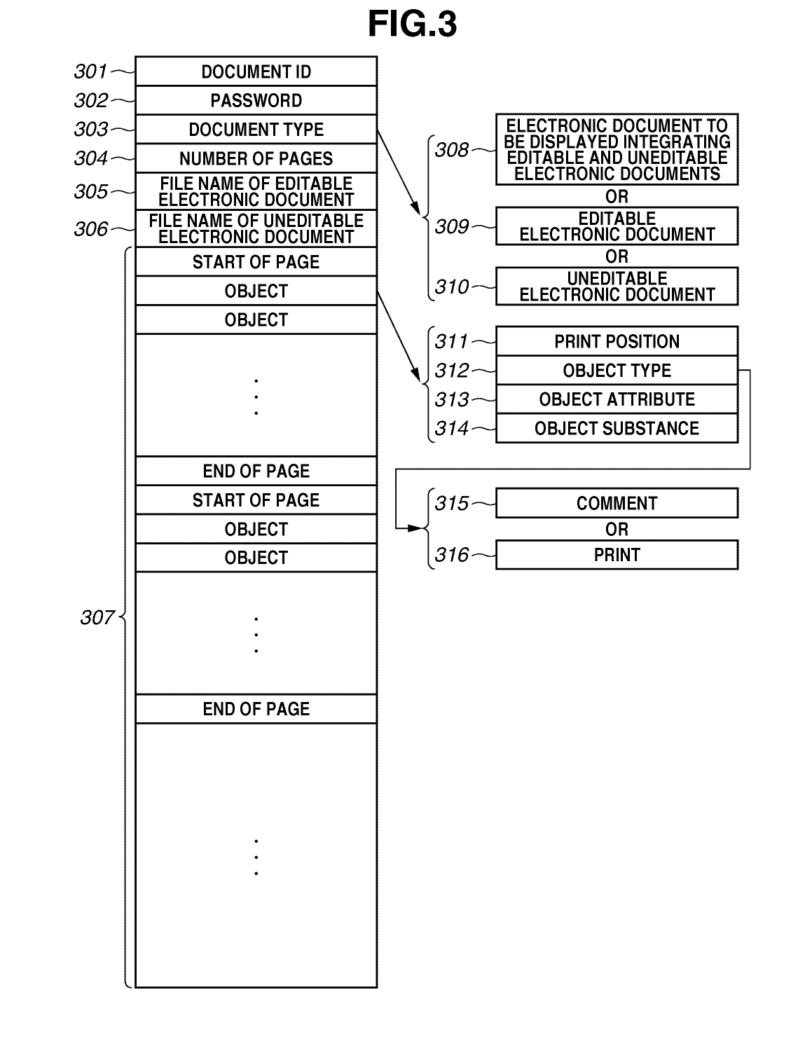

FIG. 3 illustrates an example of a format of the electronic document that can be processed by the image forming apparatus according to the present exemplary embodiment. More specifically, the example of FIG. 3 illustrates a format of the electronic document commonly used for the electronic document suitable for printing which is generated by the DM 106 (FIG. 1A).

Referring to FIG. 3, a document ID 301 is a unique ID used for identifying an electronic document. The operator can, in extracting the electronic document or instructing printing of the electronic document, designate the electronic document using the document ID 301 as well as using a file name of the electronic document.

A password 302 is used to disable the authentication of a portion of the electronic document which is determined to be normally printable in the preflight check (for example, the EDOC 202).

A document type 303 is information for identifying the type of the electronic document among three print-suitable electronic documents (i.e., which of the EDOC 203, the EDOC 202, and the EDOC 204 the electronic document is).

In the present exemplary embodiment, if the electronic document is for integrating the electronic documents, a type 308 is described in the document type 303. Furthermore, if the electronic document is the portion determined to be normally unprintable in the preflight check, a type 309 is described in the document type 303. Moreover, if the electronic document is the portion determined to be normally printable in the preflight check, a type 310 is described in the document type 303.

A number of pages 304 indicates a number of pages included in the electronic document. A file name 305 indicates a file name of the electronic document that is the portion determined as normally printable in the preflight check. A file name 306 indicates a file name of the electronic document that is the portion determined as normally unprintable in the preflight check.

A data portion 307 is used in an actual printing and includes a plurality of pages and a plurality of objects. The objects can include a character, a graphic, or an image. Furthermore, the objects include a print position 311, an object type 312, an object attribute 313, and an object substance 314.

In the present exemplary embodiment, the host computer 101 which is an example of an information processing apparatus that can edit data including an object used for forming an image is described.

The host computer 101 determines whether the object can be normally output with the resource used in specific image forming before forming an image of the object. If the host computer 101 determines that the object is normally printable, the editing of the object is restricted. On the other hand, if the host computer 101 determines that the object is normally unprintable, data that is not restricted in editing of the object is generated.

The object type 312 includes the types of the data, i.e., a comment 315 and an object to be printed 316. If the data is the comment 315, the data is not printed on paper in an actual printing.

Furthermore, if the data is the comment 315, the data is used to describe a result of the preflight check, which will be described below. The comment 315 can include a description about a ground for determining that the data is normally unprintable. By referring to the content of the comment 315, the user can easily understand which output condition is to be corrected with respect to the second electronic document.

The object attribute 313 describes whether the object is a character, a graphic, or an image. The image forming apparatus 102 changes a method for forming an image based on the content of the object attribute 313 to obtain a print product having an appropriate print quality.

If a general document format can be employed as the document format according to the present exemplary embodiment, the general document format can be used as the format for generating an electronic document suitable for printing.

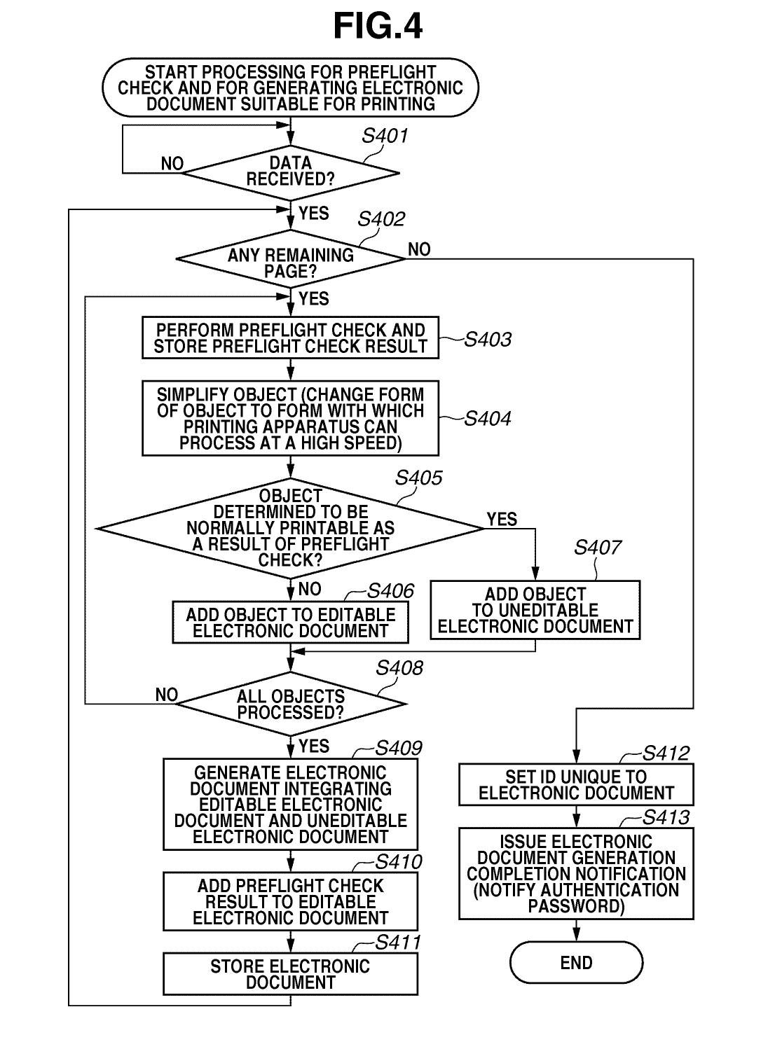

FIG. 4 is a flow chart illustrating an example of the data processing performed by the image forming apparatus according to the present exemplary embodiment. In this flow chart, document processing from the preflight check performed within the image forming apparatus 102 through generating an electronic document suitable for printing is described. Each step of the processing illustrated in FIG. 4 can be implemented by the CPU 12 (FIG. 1B) that loads and executes the DM 106 and the PFCM 104 from the external memory 110 onto the RAM 19.

Referring to FIG. 4, in step S401, the CPU 12 waits until an electronic document to be preflight-checked is received from the host computer 101. In the present exemplary embodiment, the file format of the electronic document is PDF.

When an electronic document to be preflight-checked is sent from the host computer 101, the CPU 12 activates the PFCM 104 to start the preflight check on the received electronic document.

In step S402, after starting the preflight check, the CPU 12 determines whether the preflight check of the electronic document including a plurality of pages is completed for all the pages by checking remaining pages. If it is determined in step S402 that no page to be preflight-checked remains (NO in step S402), then the CPU 12 recognizes that all the pages are preflight-checked. Then, the processing advances to step S412.

On the other hand, if it is determined in step S402 that pages to be preflight-checked remain (YES in step S402), then the processing advances to step S403. In step S403, the CPU 12 causes the PFCM 104 to perform the preflight check on the electronic document and stores a result of the preflight check (the PF result 105).

In step S404, the DM 106 performs processing for simplifying the object included in the stored electronic document and generates object information such as the printing position 311, the object type 312, the object attribute 313, and the object substance 314 (FIG. 3).

In step S405, the CPU 12 determines whether the object is determined as normally printable in the preflight check by the PFCM 104. If it is determined in step S405 that the object is normally printable in the preflight check by the PFCM 104 (YES in step S405), then the processing advances to step S407. In step S407, the CPU 12 adds the object to uneditable electronic documents. Then, the processing advances to step S408.

On the other hand, if it is determined in step S405 that the object is normally unprintable in the preflight check by the PFCM 104 (NO in step S405), then the processing advances to step S406. In step S406, the CPU 12 adds the object to editable electronic documents. Then, the processing advances to step S408.

In step S406, authentication information for editing is added to the editable electronic document and stored. The authentication information includes a password illustrated in FIG. 2. Adding the authentication information to the editable electronic document can prevent the user from instructing unnecessary editing of the object and further reediting the object.

That is, the user can recognize that the page needs input of a password for editing and positively reedit the page by entering the required password. Accordingly, the objects on the same page can be divided into an object to be reedited and an object not to be reedited.

In step S408, the CPU 12 determines whether the processing from step S403 to step S407 is completely performed for all the objects included in the page. If it is determined in step S408 that the processing is not completed for all the objects (NO in step S408), then the CPU 12 repeats the processing in step S403 and beyond. On the other hand, if it is determined in step S408 that the processing is completed for all the objects (YES in step S408), then the processing advances to step S409.

That is, when the preflight check by the PFCM 104 on one page of the electronic document is completed as described above, then the processing advances to step S409. In step S409, the CPU 12 causes the DM 106 to generate an electronic document for integrating an editable electronic document having no authentication information and an uneditable electronic document having authentication information.

In step S410, the CPU 12 causes the PFCM 104 to add authentication information to the uneditable electronic document and add a detailed preflight check result to the editable electronic document. Then, the processing advances to step S411. In step S411, the CPU 12 stores the generated three electronic documents in the external memory 110, for example.

On the other hand, if it is determined in step S402 that no page to be preflight-checked remains i.e., if the preflight check is completed for all the pages, (NO in step S402) then the processing advances to step S412.

In step S412, the CPU 12 adds a unique document ID and document information to each of the stored three electronic documents. The document information includes the password 302, the document type 303, the number of pages 304, and the file names 305 and 306 (FIG. 3).

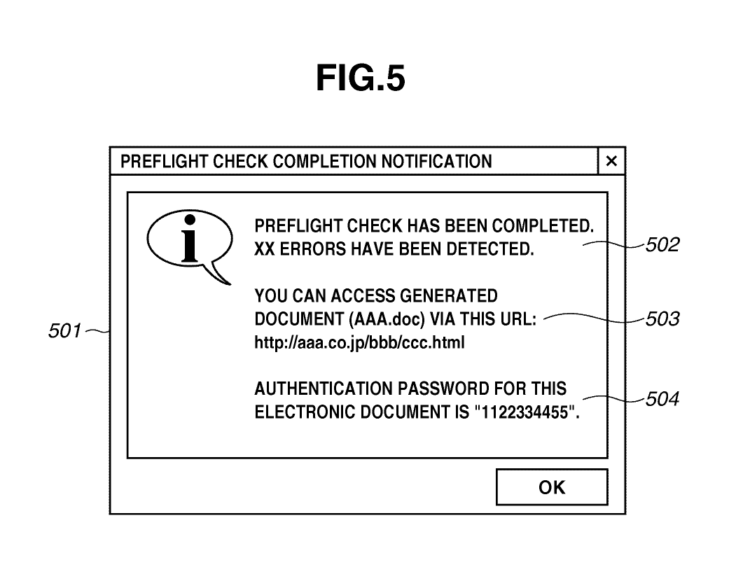

When the processing for generating the three EDOCs 202 to 204 suitable for printing is completed as described above, the processing advances to step S413. In step S413, the CPU 12 issues a completion notification to the host computer 101 or the operation unit 1012 of the image forming apparatus 102. The operation unit 1012 includes a liquid crystal display unit and a liquid crystal touch panel, for example. The operation unit 1012 displays the completion notification on the UI screen (FIG. 5).

In the completion notification, a summary of the preflight check result, the password used for user authentication, and a storage location and a file name of the electronic document suitable for printing are included.

FIG. 5 illustrates an example of a user interface displayed on a liquid crystal display unit of the image forming apparatus 102 (FIG. 1). The example illustrated in FIG. 5 is a preflight check completion notification screen displayed in step S413 (FIG. 4).

Referring to FIG. 5, an entire UI screen 501 displays a summary 502 of the preflight check result, the storage location and the file name of the electronic document suitable for printing 503, and a password 504 used for authentication processing which are notified to a user. The summary 502 notifies a user of the number of errors which corresponds to an item to be previously extracted. In the example illustrated in FIG. 5, the storage location of the electronic document is displayed as a uniform resource locator (URL) managed by a server apparatus on the network. Under a local system environment, the storage location of the electronic document can be indicated by an Internet protocol (IP) address which indicates an address of a folder on a network.

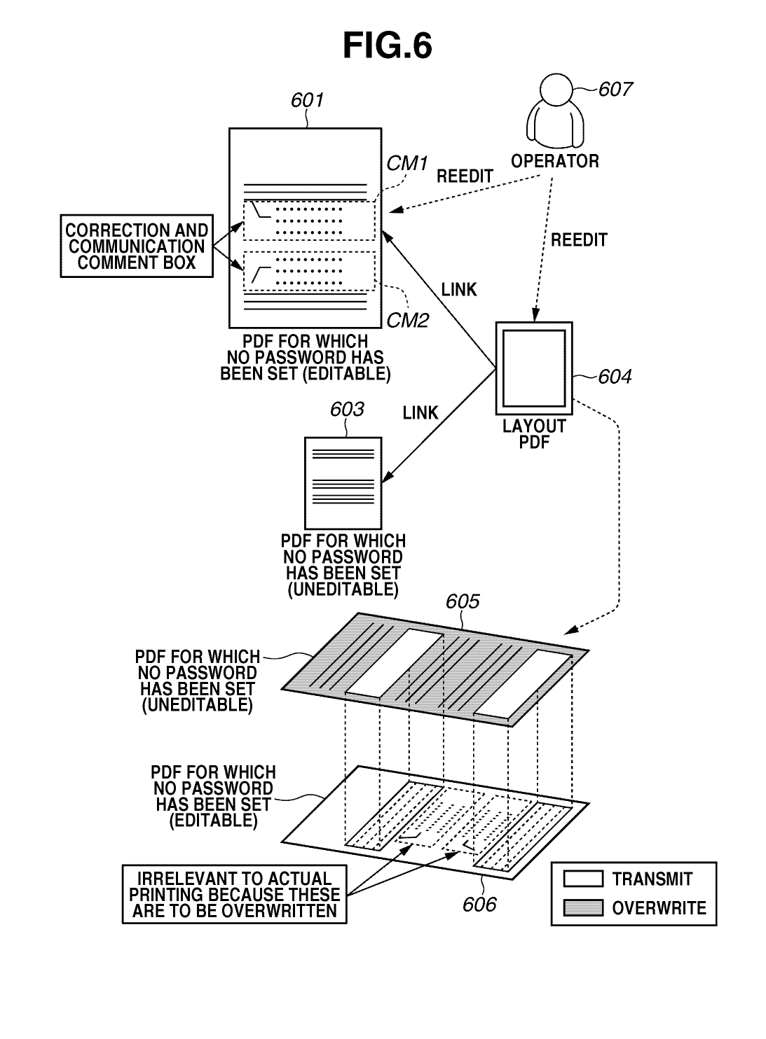

FIG. 6 illustrates an example of processing for generating an electronic document performed by the electronic document generation module (DM) 106 (FIG. 1). In the present exemplary embodiment, the file format of the electronic document 201 is PDF. Now, processing for adding the comment 315 (FIG. 3) to an electronic document suitable for printing will be described in detail below.

An electronic document that is determined to be normally unprintable in a preflight check includes a wide blank portion because the portion of the electronic document that is determined to be normally printable in the preflight check is removed therefrom. In the present exemplary embodiment, a preflight check detailed result is added to the blank portion of the electronic document as a comment. More specifically, comments CM1 and CM2 (described below) are added to the blank portion of an EDOC 601 (FIG. 6) which is determined to be normally unprintable in the preflight check.

Referring to FIG. 6, an EDOC 603 which is a first electronic document generated by the DM 106 is a portion of the electronic document that is determined to be normally printable in the preflight check. An EDOC 601 which is a second electronic document generated by the DM 106 is a portion of the electronic document 201 that is determined to be normally unprintable in the preflight check. An EDOC 604 is a third electronic document generated by the DM 106 for integrating the two EDOCs 601 and 603.

According to the present exemplary embodiment, an operator 607 can refer to the comments CM1 and CM2 and a detailed content of the preflight check at the time of reediting the EDOC 601 that is determined to be normally unprintable in the preflight check. Accordingly, the user 607 can reduce mistakes it makes in the reediting and the time taken for the processing.

When the user 607 sees through the integrating EDOC 604 , the comments CM1 and CM2 are insertably disposed in a normally printable area of an EDOC 605. Accordingly, a comment portion of the electronic document (an EDOC 606) having a comment and determined as normally unprintable in the preflight check is hidden when the EDOC 606 is displayed. This is because each of the comment CM1 and the comment CM2 is overwritten when the EDOC 605 which is determined to be normally printable in the preflight check is displayed.

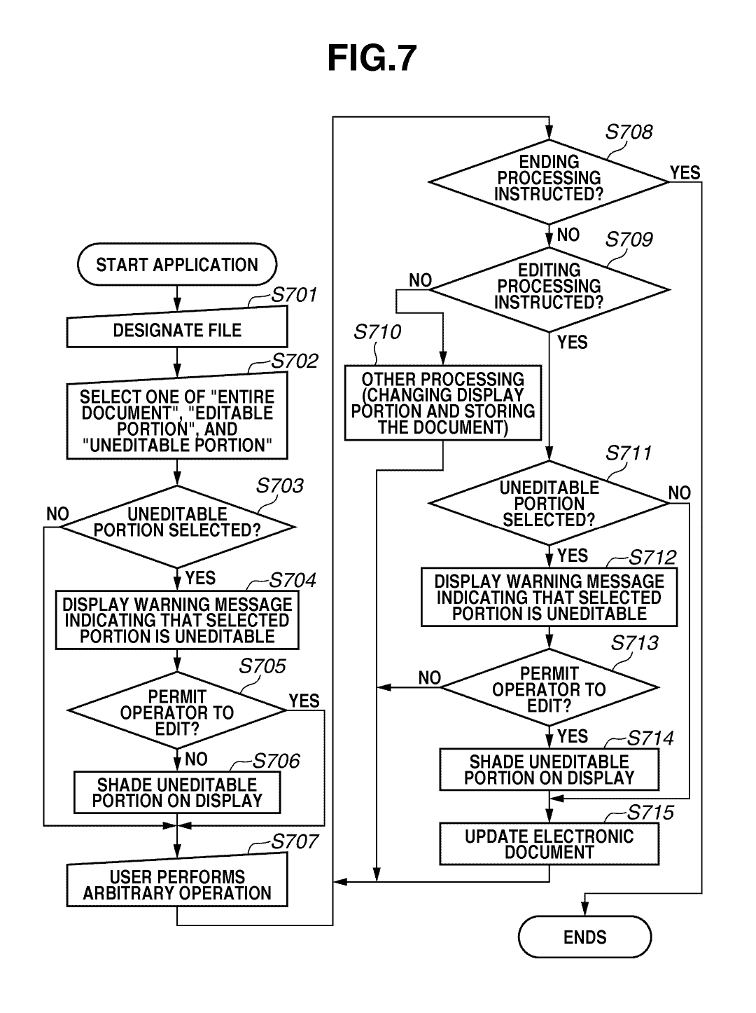

FIG. 7 is a flow chart illustrating an example of data processing performed by the image forming apparatus according to the present exemplary embodiment. FIG. 7 illustrates exemplary processing for reediting an electronic document. Each step of the processing illustrated in FIG. 7 can be implemented by the CPU 12 of the image forming apparatus 102 (FIG. 1B) that loads and executes a control program (an application) from the external memory 110 onto the RAM 19.

A flow of processing performed with the application used by the operator for reediting an electronic document according to the present exemplary embodiment will be described below. In the present exemplary embodiment, the application for reediting an electronic document operates on the image forming apparatus 102. However, the electronic document reediting application can also operate on the host computer 101.

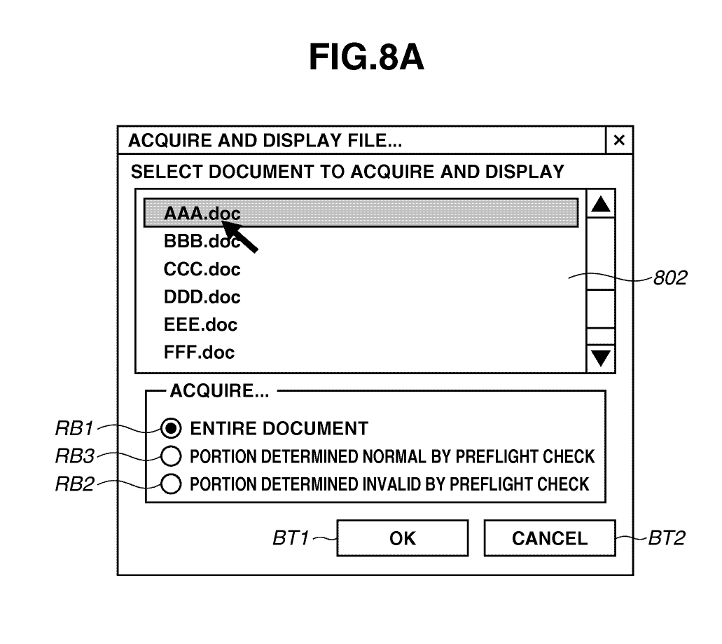

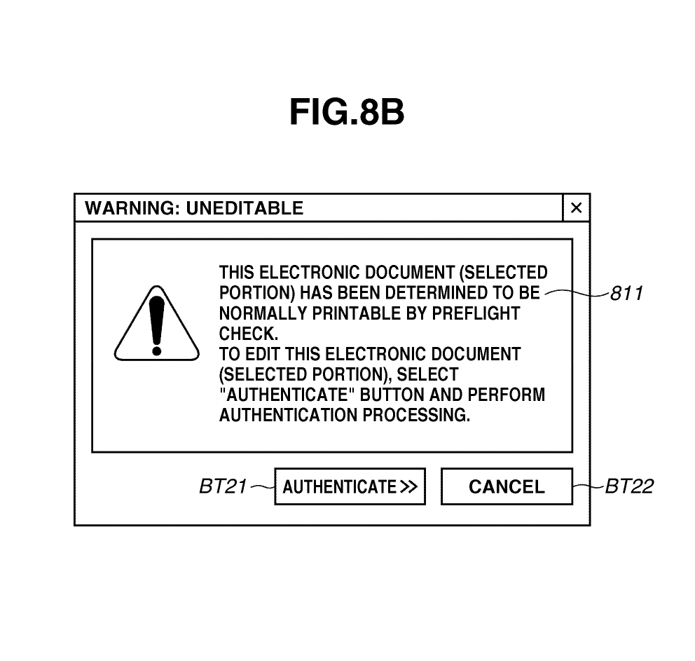

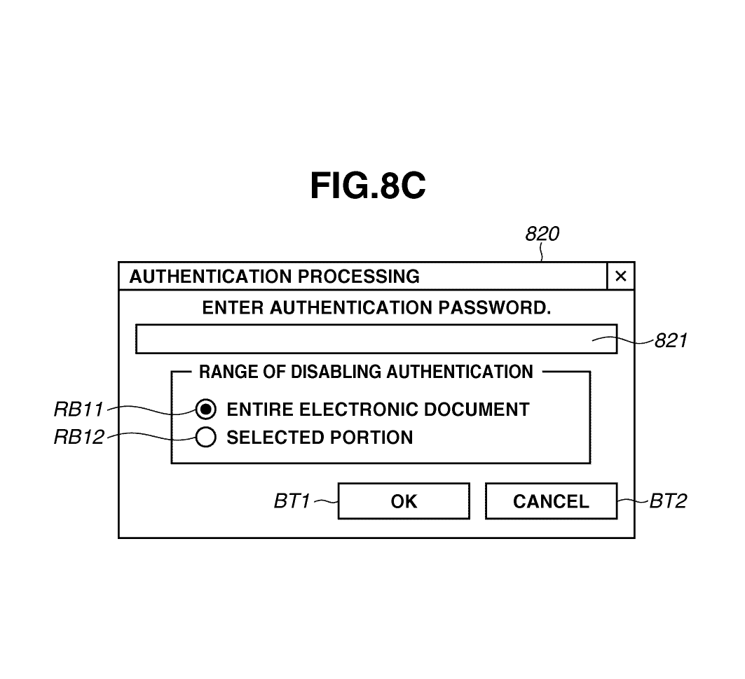

Referring to FIG. 7, after the operator started the electronic document reediting application, in step S701, the application displays on the operation unit 1012 a user interface illustrated in FIG. 8A for designating an electronic file to be edited and which one of the three electronic documents is to be opened as a UI screen.

FIGS. 8A through 8C each illustrate an example of a user interface that can be displayed on the image forming apparatus 102 according to the present exemplary embodiment. FIG. 8 A illustrates a file acquisition and display screen. FIG. 8B illustrates an uneditable electronic document warning screen. FIG. 8C illustrates an authentication processing screen.

Referring to FIG. 8A, radio buttons RB1 through RB3 can be operated by a user to designate a method for acquiring a desired electronic document. Buttons BT1 (an OK button) and BT2 (a cancel button) each can be operatedby the user to finalize or cancel the designation for selecting an electronic document to acquire.

The radio button RB1 is selected to take an alternative “entire document” including the three EDOCs. That is, the radio button RB1 is selected to take the integrating EDOC and open both the portion of the electronic document determined to be normally printable and the portion of the electronic document determined to be normally unprintable in the preflight check.

The radio button RB2 is selected to take an alternative “portion determined invalid by preflight check”. That is, the radio button RB2 is selected to open a portion of the uneditable electronic document to which authentication for the portion determined to be normally unprintable in the preflight check is added.

The radio button RB3 is selected to take an alternative “portion determined normal by preflight check”. That is, the radio button RB3 is selected to open the editable electronic document that is the portion determined to be normally printable in the preflight check.

In step S702, the operator selects one of the radio buttons RB1 through RB3 to take the entire document, the editable portion, or the uneditable portion.

After the operator designated the electronic file to be to be opened, in step S703, the application determines whether the EDOC that is an uneditable portion (the portion determined to be normally printable in the preflight check) is designated by the operator.

In the present exemplary embodiment, the application determines that the electronic file that is an uneditable portion is selected in a case where the operator selects the radio button RB1 to take the alternative “entire document” or the radio button RB3 to take the alternative “portion determined normal by preflight check”, as described above with reference to FIG. 8A.

If it is determined in step S703 that the electronic file that is the uneditable portion is not selected (NO in step S703), then the processing advances to step S707.

On the other hand, if it is determined in step S703 that the electronic file that is the uneditable portion is selected (YES in step S703), then the processing advances to step S704. In step S704, the application displays on the operation unit 1012 a UI screen (FIG. 8B) for warning of an uneditable electronic document and for allowing the operator to determine whether to perform the authentication processing.

The UI screen illustrated in FIG. 8B includes a comment 811 for warning the operator that the electronic document is uneditable and a button BT21 for opening an authentication window 820 (FIG. 8C) that prompts the user to perform the authentication processing in the case of editing the electronic document. Furthermore, the UI screen includes a cancel button BT22 which can be pressed by the operator to return the display to the UI screen illustrated in FIG. 8A without performing the authentication processing.

When performing the authentication processing, the operator presses the button BT21 to display the authentication UI illustrated in FIG. 8C on the operation unit 1012.

The user interface illustrated in FIG. 8C includes a password input unit 821 and radio buttons RB11 and RB12 for identifying a range of disabling the authentication. When the operator enters the notified password 504 (FIG. 5) in the password input unit 821, the portion determined to be normally printable can be made editable.

Referring to FIG. 8C, when the operator selects the radio button RB11, the entire document is designated as the range of disabling the authentication. When the radio button RB12 is selected by the operator, a currently selected portion (this portion can be designated per page, chapter, or object) is designated as the range of disabling the authentication.

By selecting the radio buttons RB11 and RB12, the operator can set the entire page as the portion to be edited or restrict the portion to be edited to a limited area. Thus, a wrong editing portion caused by mistake can be limited to a page or a part of a page.

If it is determined in step S705 that the user does not instruct to set the electronic document editable (that is, the operator does not perform the authentication processing, No in step S705), then the processing advances to step S706. In step S706, the application displays the uneditable portion in a shaded view to inhibit the operator from editing the electronic document. By controlling the display to visually distinguish the normally printable portion from portions other than the normally printable portion, the user can easily recognize a normally printable portion and a normally unprintable portion.

On the other hand, if it is determined in step S705 that the operator has performed the authentication processing via the UI illustrated in FIG. 8C (YES in step S705), then the application normally displays the uneditable portion of the electronic document to permit editing of the electronic document by the operator. The present exemplary embodiment can flexibly respond to a user's desire to reedit a portion determined to be uneditable in the preflight check. Thus, the present exemplary embodiment can improve usability.

In step S707, the application receives the input by an arbitrary operation of the operator via the operation unit 1012. The arbitrary operation includes editing, changing display position, storing, and ending the processing of the electronic document.

In step S708, the application determines whether the operator has issued an instruction for ending the processing. If it is determined in step S708 that the operator has issued an instruction for ending the processing (YES in step S708), then the processing ends.

On the other hand, if it is determined in step S708 that the operator has not issued an instruction for ending the processing (NO in step S708), then the processing advances to step S709. In step S709, the application determines whether the operator has issued an instruction for performing the editing processing.

The user can issue an operation request by a simple selection operation via the user interface displayed on the operation unit 1012. Accordingly, the CPU 12 performs control for displaying the screen including a button for instructing ending of processing on the operation unit 1012.

If it is determined in step S709 that the operator has not issued an instruction for performing the editing processing (NO in step S709), then the processing advances to step S710. In step S710, the application performs other processing and returns to step S708. The other processing includes changing of the display position and storing the electronic document.

On the other hand, if it is determined in step S709 that the operator has issued an instruction for performing the editing processing (YES in step S709), then the processing advances to step S711. Instep S711, the application determines whether the portion designated as the target of the editing processing is an uneditable portion or an uneditable electronic document. If it is determined in step S711 that the portion designated as the target of the editing processing is neither an uneditable portion nor an uneditable electronic document (NO in step S711), then the processing advances to step S715. In step S715, the application reflects a content of the editing on the electronic document. Then, the processing returns to step S708.

On the other hand, if it is determined in step S711 that the portion designated as the target of the editing processing is an uneditable portion or an uneditable electronic document (YES in step S711), then the processing advances to step S712. In step S712, the application displays the user interface illustrated in FIG. 8B on the operation unit 1012 and displays a warning of uneditable document.

In step S713, the application determines whether the operator has performed the authentication processing to set the electronic document editable while displaying the UI illustrated in FIG. 8C. If it is determined in step S713 that the operator has performed the authentication processing to set the electronic document editable (i.e., the operator pressed the button BT1 (FIG. 8C)) (YES in step S713), then the processing advances to step S714.

In step S714, the application disables the shaded display of the portion displayed as an uneditable portion to set the portion editable. If it is determined in step S713 that the portion designated by the operator has not been set editable (NO in step S713), then the processing returns to step S708.

In step S715, the application reflects the content of the editing performed by the operator on the electronic document. Then, the processing by the application ends.

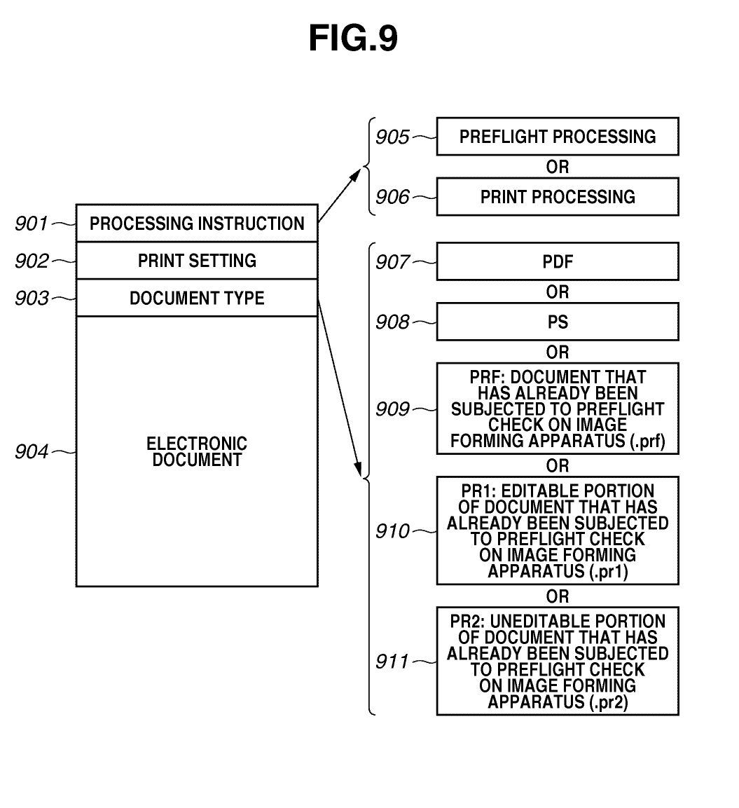

FIG. 9 illustrates an example of a format of an electronic document edited on the image forming apparatus according to the present exemplary embodiment. FIG. 9 illustrates an exemplary format of the electronic document in the case of requesting a preflight check or a printing from the host computer 101 to the image forming apparatus 102.

Referring to FIG. 9, in the case of requesting a preflight check or a printing from the host computer 101 to the image forming apparatus 102, the electronic document format includes headers 901 through 903 attached to an electronic document substance 904.

The electronic document substance 904 is an electronic document such as a PDF document or a PS document when the electronic document is sent from the host computer 101 to the image forming apparatus 102 for the first time. At the time of sending the electronic document for the second time and beyond, the electronic document substance 904 is an electronic document suitable for printing illustrated in FIG. 3. The “sending of the electronic document for the second time and beyond” refers to the sending of the electronic document to perform a re-determination processing on the electronic document that is edited to be normally printable by the PFCM 104.

In the example illustrated in FIG. 9, a portion “processing instruction” in a header 901 indicates whether preflight processing 905 or print processing 906 has been requested. The external I/F 113 of the image forming apparatus 102 distributes the processing on the electronic document to either the preflight processing 905 or the print processing 906 based on the content of the header 901.

Various print settings are included in the print processing 906. The print setting includes a setting for a test printing, two-sided printing, the number of prints, a layout, and a designation on a page to be printed.

The header 903 includes an electronic document type. More specifically, the header 903 includes types 907 through 911 of the electronic document substance 904. The type 907 indicates that the electronic document type is PDF. The type 908 indicates that the electronic document type is PS. The type 909 indicates that the electronic document type is PRF which is the electronic document already preflight-checked on the image forming apparatus 102.

The type 910 indicates that the electronic document type is PR1 which is an editable portion of the electronic document that is already preflight-checked on the image forming apparatus 102. The type 911 indicates that the electronic document type is PR2 which is an uneditable portion of the electronic document that is already preflight-checked on the image forming apparatus 102.

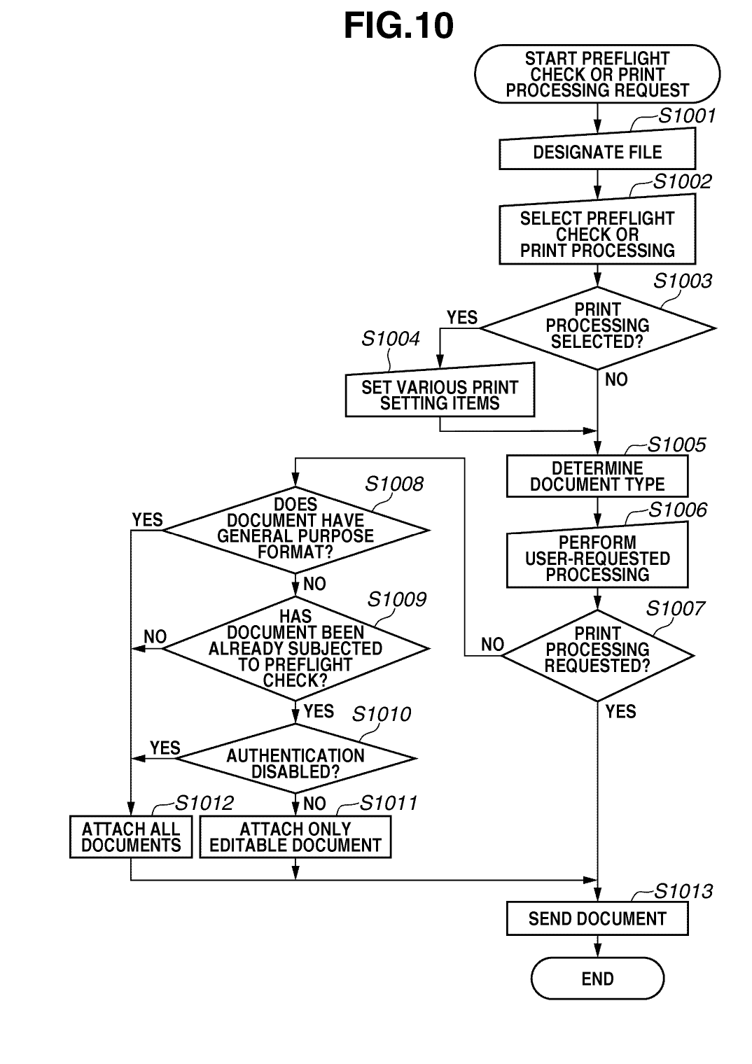

FIG. 10 is a flow chart illustrating an example of data processing performed by the information processing apparatus according to the present exemplary embodiment. FIG. 10 corresponds to processing performed when a preflight check or print processing has been requested from the host computer 101. Each step of the processing illustrated in FIG. 10 can be implemented by the CPU 1 of the host computer 101 that loads and executes a control program (an application) from the external memory 11 onto the RAM 2. The processing illustrated in FIG. 10 can be performed by starting a printer driver or a utility stored on the external memory 11 of the host computer 101. That is, the function of the processing illustrated in FIG. 10 can be provided as a function of the printer driver or the utility.

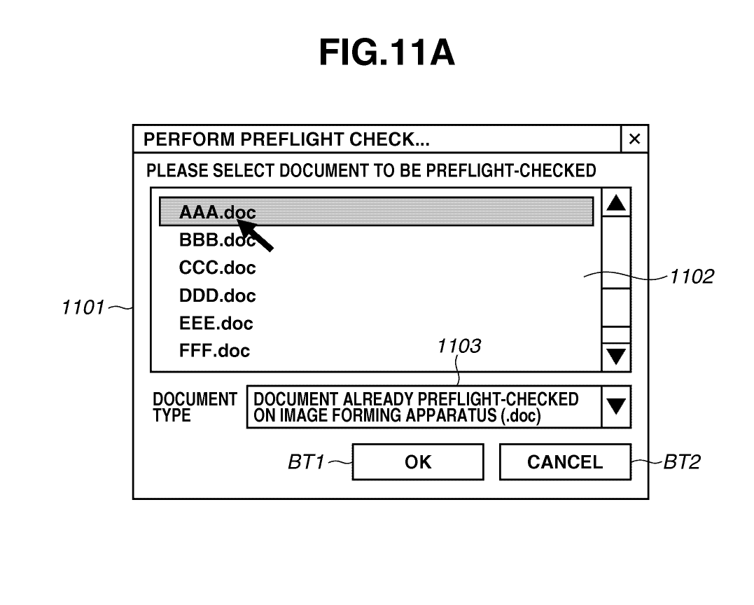

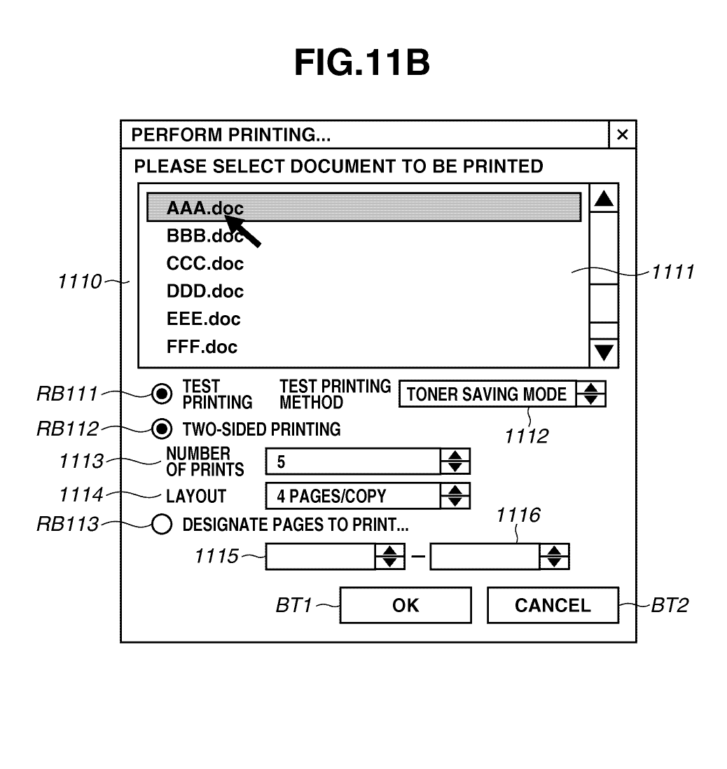

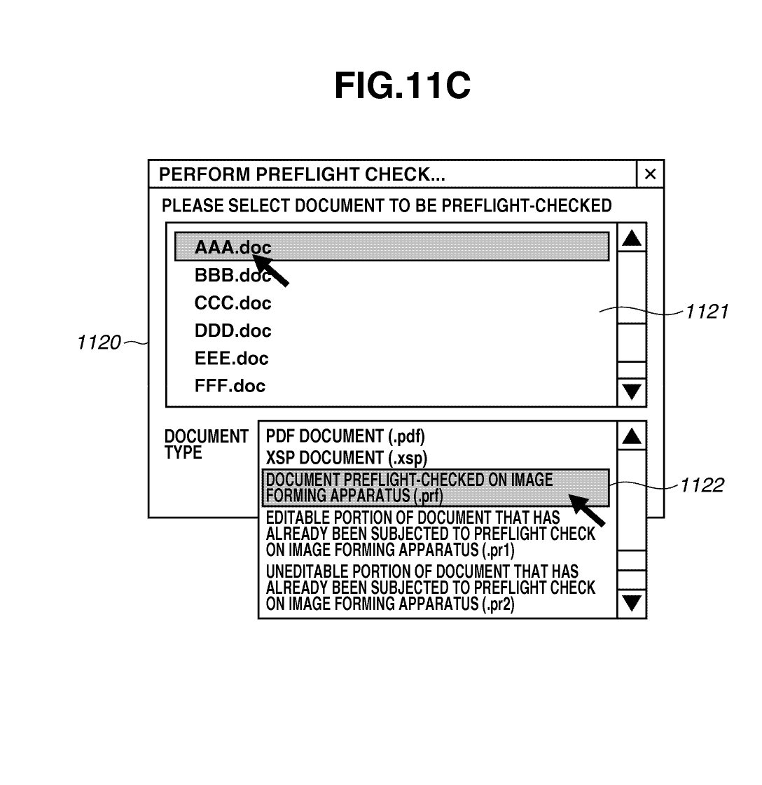

Referring to FIG. 10, in step S1001, the operator operates the KB 9 to select a file from a list of files (FIG. 11A) displayed on the display unit 10. In step S1002, the operator selects either a preflight check or print processing as the processing to be performed on the electronic document selected in step S1001.

The result of the selection by the operator in step S1002 is set in the portion “processing instruction” in the header 901 of the electronic document format to be sent from the host computer 101, as described above with reference to FIG. 9.

In step S1003, the CPU 1 determines whether print processing has been selected in step S1002. If it is determined in step S1003 that the print processing is selected (YES in step S1003), then the processing advances to step S1004. In step S1004, the CPU 1 performs various print settings. Then, the processing advances to step S1005.

The content of the print settings set in step S1004 is reflected in the portion “print setting” in the header 902 in the electronic document format to be sent from the host computer 101, as described above with reference to FIG. 9.

On the other hand, if it is determined in step S1003 that processing other than the print processing is selected (NO in step S1003), then the processing advances to step S1005. In step S1005, the CPU 1 checks the type of the document format of the file selected on a UI screen illustrated in FIG. 11A. In step S1006, the request selected by the operator is performed. Then, the CPU 1 sets the document type “PDF” or “PS” to the portion “document type” in the header 903 in the electronic document format to be sent from the host computer 101.

In step S1007, the CPU 1 determines, based on the content of the header 901, whether requested processing is “print processing”. If it is determined in step S1007 that the requested processing is “print processing” (YES in step S1007), then the processing advances to step S1013. In step S1013, the CPU 1 sends the electronic document without attaching the electronic document substance 904 thereto. Then, the processing ends.

On the other hand, if it is determined in step S1007 that the requested processing is not “print processing” based on the content of the header 901, that is, if it is determined here that the requested processing is “preflight check processing” (the preflight processing 905), then the processing advances to step S1008.

In step S1008, the CPU 1 determines whether the document format of a selected file is a general-purpose document format such as “PDF” or the “PS”. If the CPU 1 determines in step S1008 that the document format of a selected file is the general-purpose document format (YES in step S1008), then the processing advances to step S1012. In step S1012, the CPU 1 attaches all the documents to the electronic document substance 904. Then in step S1013, the CPU 1 sends the document to the image forming apparatus 102 and the processing ends.

On the other hand, if the CPU 1 determines in step S1008 that the document format of the selected file is an electronic format suitable for printing (NO in step S1008), then the processing advances to step S1009. In step S1009, the CPU 1 determines whether the selected file has already been preflight-checked. If it is determined in step S1009 that the selected file has not yet been preflight-checked (NO in step S1009), then the processing advances to step S1012. On the other hand, if it is determined in step S1009 that the selected file has already been preflight-checked (YES in step S1009), then the processing advances to step S1010. In step S1010, the CPU 1 determines whether the authentication has been disabled.

If the CPU 1 determines in step S1010 that the authentication has not been disabled (NO in step S1010), then the processing advances to step S1011. In step S1011, the CPU 1 attaches only an editable electronic document (a portion that has been determined to be normally unprintable by the previous preflight check). Then, in step S1013, the CPU 1 sends to the image forming apparatus 102 only the portion that has been determined to be normally unprintable via the NIC 8. Then, the processing ends.

On the other hand, if the CPU 1 determines in step S1010 that the authentication has been disabled (YES in step S1010), then the CPU 1 attaches all electronic documents in step S1012. Then, in step S1013, the CPU 1 sends all electronic documents to the image forming apparatus 102 via the NIC 8 and the processing ends.

Accordingly, a size of a file sent when preflight check processing is requested for the second time and beyond can be appropriately reduced. Thus, the processing speed can be improved.

FIGS. 11A through 11C each illustrate an example of a user interface displayed on the information processing apparatus according to the present exemplary embodiment. More specifically, each of FIGS. 11A through 11C illustrates an exemplary UI screen used for requesting a preflight check or print processing on the host computer 101. The UI screen illustrated in each of FIGS. 11A through 11C can be provided as a function of the printer driver or a function of the utility.

Referring to FIG. 11A, a file selection screen 1101 includes a file selection window 1102 for selecting a file to be processed and a check box 1103 for selecting the preflight check or the print processing as the requested processing.

The operator selects a file via the window 1102, selects the processing to be performed via the check box 1103, and presses the button BT1 functioning as a request execution button to perform the requested processing. A button BT2 is a cancel button to cancel the requested processing.

Referring to FIG. 11A, if the requested processing is print processing, a print setting UI 1110 illustrated in FIG. 11B is displayed.

Referring to FIG. 11B, the operator presses radio buttons RB111 through RB113 to perform various print settings (settings for test printing, two-sided printing, a layout, and a designation of the page(s) to be printed). If test printing is selected as the print method, an input unit 1112 for designating the details of the test printing enters an active state so that the operator can designate a mode such as a toner saving mode via the input unit 1112. A document to be printed is designated in an area 1111.

The operator can designate the number of prints from a column 1113. Furthermore, the operator can designate a layout method, namely, the number of pages to be included in one sheet as its layout (N in 1), can be designated from a column layout 1114. In this case, the number of pages (N) to be included in one sheet is indicated as “N pages/sheet”.

Furthermore, the operator can designate a print range of pages by selecting the radio button RB 113 and inputting the page number of a print start page 1115 and the page number of a print end page 1116.

The operator selects a file to be preflight-checked via a file selection screen 1121 on a preflight check performing UI 1120 illustrated in FIG. 11C. The preflight check performing UI 1120 includes a document type selection field 1122. In the example in FIG. 11C, an already preflight-checked document (.prf) has been selected as the file type.

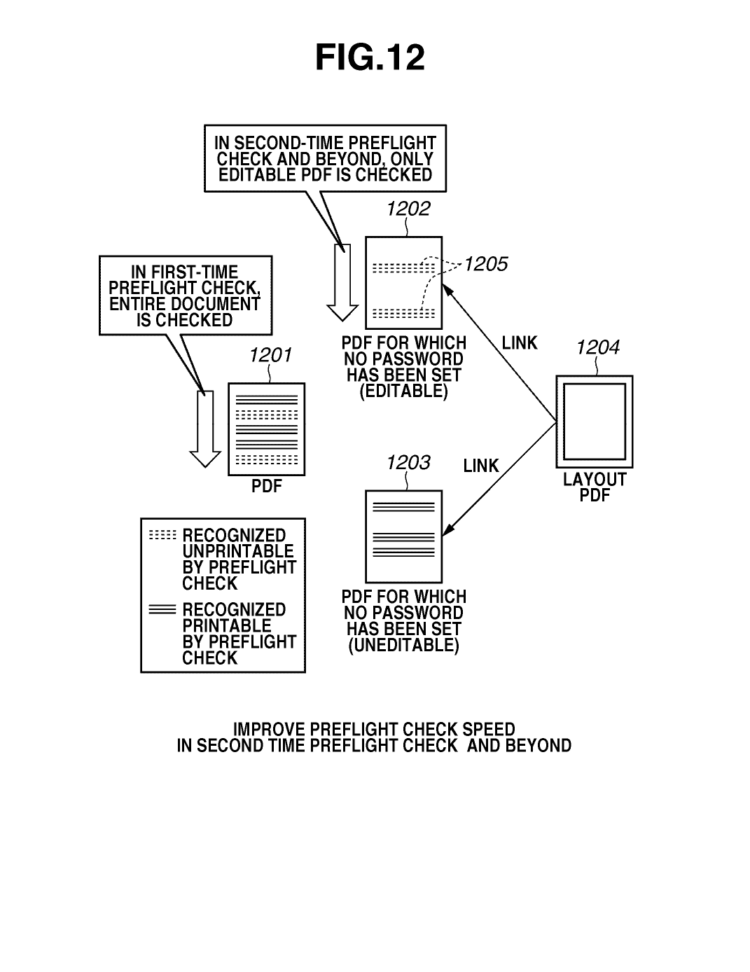

FIG. 12 illustrates exemplary preflight check processing performed on the image forming apparatus according to the present exemplary embodiment. Now, processing for performing a second-time preflight check and beyond at a high speed will be described below. In the present exemplary embodiment, the type of the electronic document is PDF.

Referring to FIG. 12, in a first-time preflight check, it takes a long time because the preflight check is performed on all objects included in an electronic document 1201.

On the other hand, with respect to a second-time preflight check and beyond, it is not necessary to perform a preflight check on an object included in an electronic document 1203 which has been determined to be normally printable by the first-time preflight check and on an integrating electronic document 1204.

Accordingly, only an object included in the electronic document 1202 which has been determined to be normally unprintable by the first-time preflight check is preflight-checked.

Thus, the number of objects to be preflight-checked can be reduced. Accordingly, the present exemplary embodiment can perform a preflight check at a high speed. Portions 1205 are recognized as unprintable portions by the preflight check.

In the present exemplary embodiment, if the authentication set on an electronic document determined as normally unprintable in the preflight check is disabled, a subsequent preflight check is performed as a first-time preflight check, and the entire electronic document is subjected to the first-time preflight check.

In the first exemplary embodiment, the instruction for correcting the object that has been determined in the preflight check is notified to the user in the form of a comment. However, in the case of using a comment, the user may not easily understand grounds for determining as normally unprintable. For example, if it is difficult to determine the ground without visually verifying, for example, a resolution and a tint of the printing unit 17, the user cannot easily understand the comment indicating such a ground. In this regard, a second exemplary embodiment visually notifies a user of a content of an object to be corrected in the preflight check, to efficiently perform a correction.

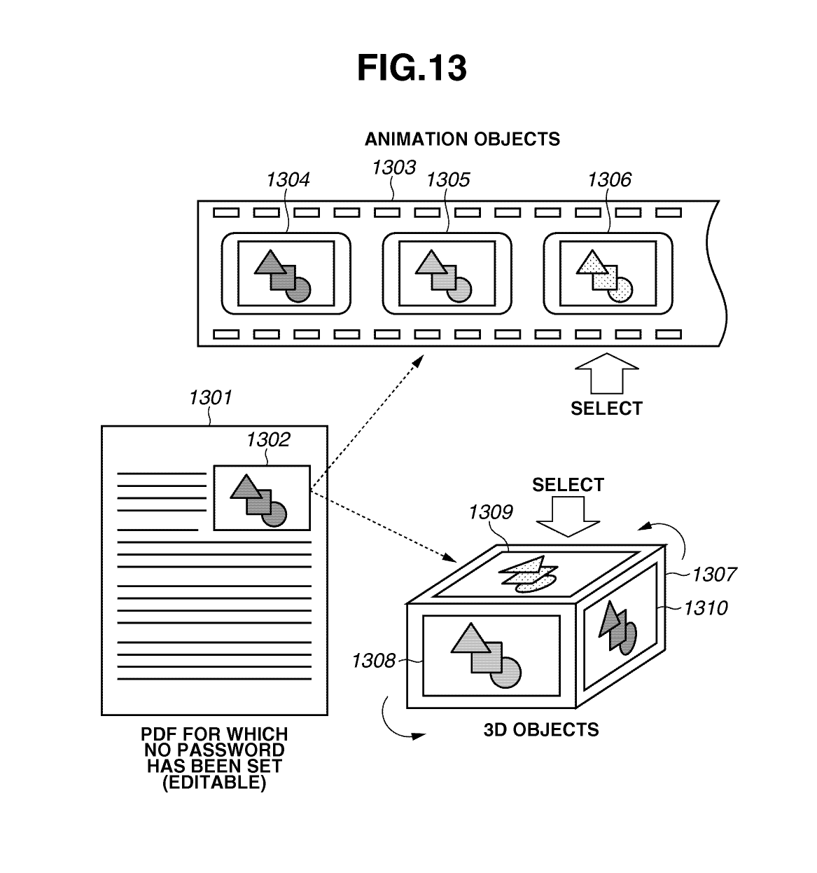

An example for embedding correction candidates as animation objects or three-dimensional objects for an object determined to require correction in a preflight check will be described with reference to FIG. 13.

FIG. 13 illustrates an example of an electronic document that can be processed on the information processing apparatus according to the present exemplary embodiment.

A PDF page 1301 includes an object 1302. Suppose that in the example illustrated in FIG. 13, the object 1302 is determined to be normally unprintable in a preflight check.

If it is determined that the object 1302 cannot be printed with a normal color or brightness due to the capacity of the image forming apparatus 102, the correction candidate generation module 117 generates a plurality of types of objects that is corrected to be printable with the capacity of the image forming apparatus 102. Then, the correction candidates generated by the correction candidate generation module 117 are embedded in an animation object 1303 as objects 1304, 1305, and 1306 whose correction method differs from one another. Here, the number of the objects as the correction candidate is not limited to three.

The operator activates the animation, stops the animation at a position of a desired correction candidate, and then sends the electronic document including the position of the object to be corrected to the image forming apparatus 102.

The image forming apparatus 102 performs a preflight check with respect to the position of the animation object 1303 displayed at the time of storing the electronic document, and prints the electronic document.

In the case of a three-dimensional object, the correction candidate generation module 117 can generate a plurality of correction candidates 1307 through 1310 which can be embedded, as in the case of the animation object 1303. In addition, the user can change and determine whether to display animation object correction candidates or three-dimensional object correction candidates by operating a button on the UI screen. Alternatively, whether to display the three-dimensional object correction candidates or the animation object correction candidates can be automatically displayed according to the number of generated candidates.

In the case of using three-dimensional objects for the correction candidates, the image forming apparatus 102 performs a preflight check with respect to the position of the three-dimensional object displayed at the time of storing the electronic document, and prints the electronic document.

The operator operates the pointing device to rotate the three-dimensional object, stops the three-dimensional object at the position of the desired correction candidate, and sends the electronic document to the image forming apparatus 102 in this state.

The operator can easily select a correction candidate by operating the animation and rotating the three-dimensional object. Furthermore, the operator can prevent changing of the layout that may be performed by mistake.

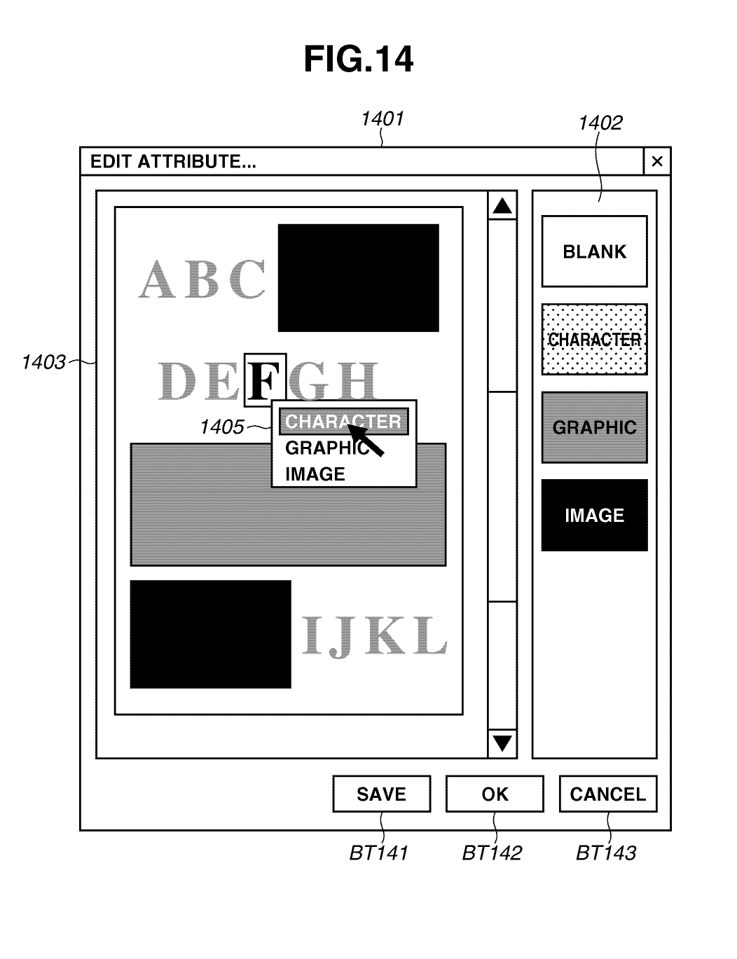

Now, a method for editing an object attribute included in an electronic document is described with reference to FIG. 14.

FIG. 14 illustrates an example of processing of an object performed by the information processing apparatus according to the present exemplary embodiment. In the present exemplary embodiment, an application for editing an object attribute uses different colors for different objects based on the object attribute 313 (FIG. 3). That is, the object attribute editing application uses different shading types for different objects.

Referring to FIG. 14, an object attribute editing screen 1401 includes attribute patterns 1402. The attribute pattern 1402 indicates which color (shading type) corresponds to which object attribute and indicates which object attribute is used in an actual page 1403. In FIG. 14, a selection field 1405 indicates that a character is determined to have an image attribute. Furthermore, the object attribute editing screen 1401 includes buttons BT141 through BT143.

If a character is described in a character code in an electronic document, the character can be determined to be a character. However, if a character code is rasterized into a bitmap image on the host computer 101 before being sent to the image forming apparatus 102, the character is liable to be erroneously determined as an image.

In this case, in order to change the attribute of the character from the image attribute to the character attribute, the operator clicks a corresponding portion with a pointing device and selects the desired attribute from the attribute pattern 1402 to appropriately change the attribute.

A third exemplary embodiment of the present invention is described below. In the present exemplary embodiment, a method is described that prevents mistakenly editing a portion of one electronic document suitable for printing, which is determined to be normally printable in a preflight check. Here, it is desired not to change the portion that is determined to be normally printable. That is, if a user can freely edit the portion that is determined to be normally printable, the portion may be determined as normally unprintable by a further preflight check.

Here, tag information can be added to an electronic document suitable for printing. The tag information is used for adding an attribute to an electronic document or a portion of an electronic document. The tag information includes a preflight check result. The application determines whether to permit the operator to edit the electronic document based on the preflight check result described in the tag information.

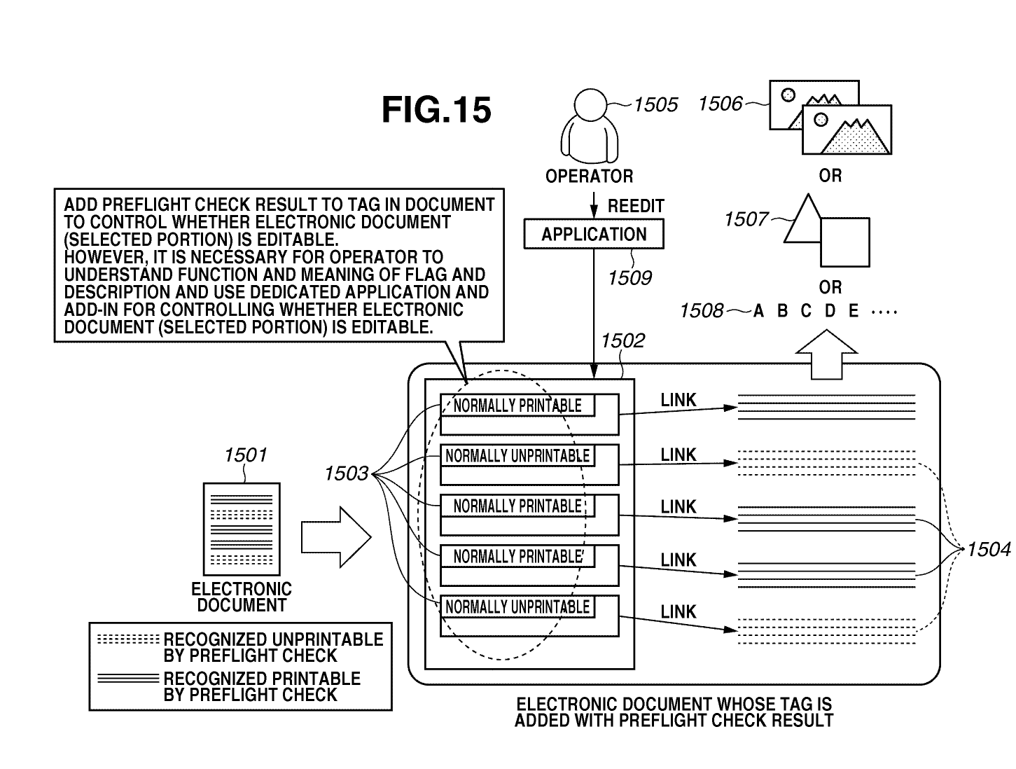

FIG. 15 illustrates an example of processing for editing an electronic document performed by the information processing apparatus according to the present exemplary embodiment. Now, processing for adding a preflight check result to tag information is described.

The processing is implemented by executing an application installed on the external memory 11 of the host computer 101. An application 1509 operates on the host computer 101 or the image forming apparatus 102. The processing can be performed on the image forming apparatus 102 by installing the application on the external memory 110 of the image forming apparatus 102.

Referring to FIG. 15, an electronic document 1501 to be preflight checked is converted into an electronic document suitable for printing 1502 after the preflight check.

Tag information 1503 is included in the electronic document suitable for printing 1502, and a result of the preflight check is added to the tag information 1503. The result of the preflight check includes a determination as to whether the electronic document suitable for printing 1502 can be normally printed.

An operator 1505 refers to the result of the preflight check added to the tag information included in the electronic document suitable for printing 1502, and then edits the electronic document suitable for printing 1502 with an application 1509 having a function for determining whether an electronic document can be edited.

The application 1509 does not permit the operator 1505 to edit a portion that is determined to be normally printable as a result of the preflight check and enclosed by the tag information 1503.

The application 1509 can be installed on the host computer 101 or the image forming apparatus 102. In this case, the application 1509 can be downloaded and executed from one of the host computer 101 or the image forming apparatus 102 in which the application 1509 is installed.

With this configuration, the present exemplary embodiment can prevent the operator from editing by mistake the portion that is determined to be normally printable as the result of the preflight check by using the electronic document suitable for printing 1502.

The tag information 1503 included in the electronic document suitable for printing 1502 includes a plurality of objects 1504. The plurality of objects 1504 can be a plurality of images 1506, a plurality of graphics 1507, and a plurality of characters 1508. Furthermore, a plurality of objects of different object types, for example, a graphic and a character, can be designated.

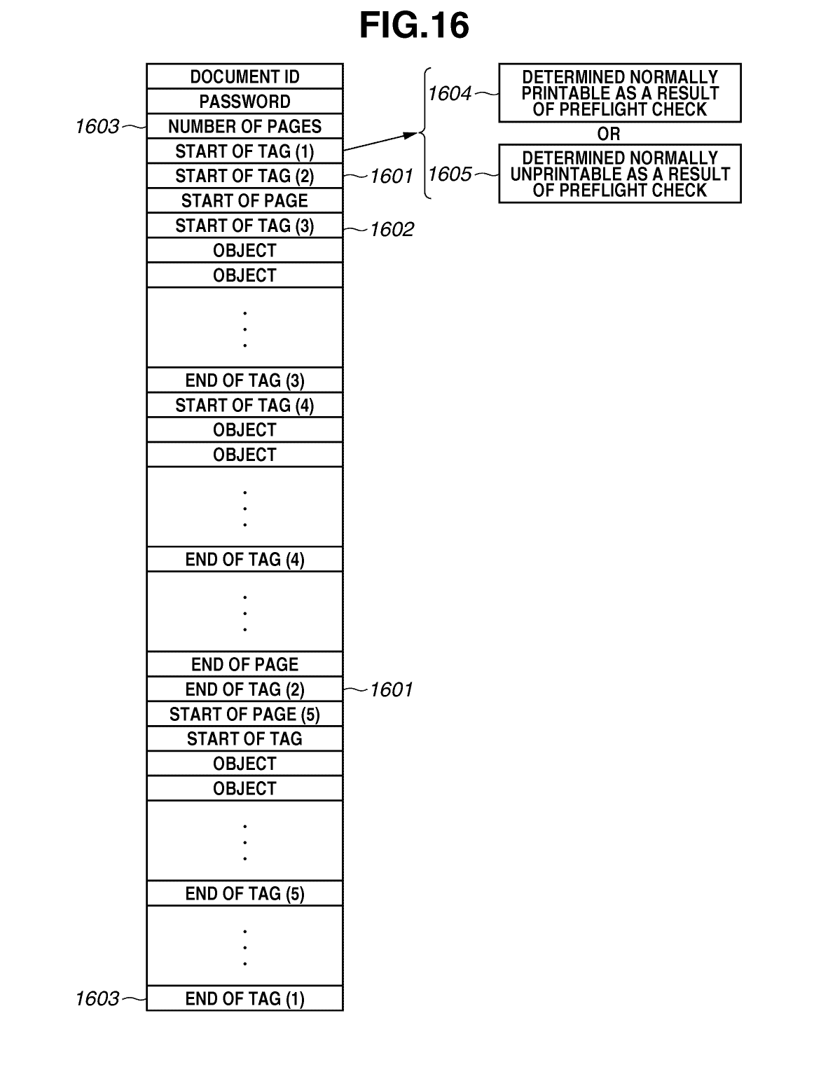

Now, an electronic document format suitable for printing and whose tag information can include a result of a preflight check is described in detail below with reference to FIG. 16.

FIG. 16 illustrates an example of a format of the electronic document 1502 illustrated in FIG. 15.

Referring to FIG. 16, the electronic document 1502 (FIG. 15) includes tag information 1601 through 1603. The tag information 1601 through 1603 include information about whether the electronic document 1502 is determined to be normally printable (information 1604) or to be normally unprintable (information 1605) in the preflight check. The content of the tag information 1601 through 1603 corresponds to a preflight check result included in the tag information 1503 (FIG. 15).

The tag information 1601 is a tag for designating the entire page. The tag information 1601 is added if the results of preflight checks are mutually the same for all objects included in the page. For example, the tag information 1601 is added if it is determined that all objects included in a page can be normally printed and the entire page is designated as uneditable.

The tag information 1602 can add information for determining whether the object is normally printable or unprintable in the preflight check to some of a plurality of objects included in a page. Owing to the tag information 1602, the object that is determined to be normally printable in the preflight check becomes uneditable and the object that is determined to be normally unprintable in the preflight check becomes editable.

The tag information 1603 is a tag for designating the entire electronic document. The tag information 1603 is added if the preflight check results for all the objects included in the electronic document are mutually the same. More specifically, the tag information 1603 is added if all the objects included in the electronic document is determined to be normally printable in the preflight check and the entire electronic document is designated as uneditable, for example.

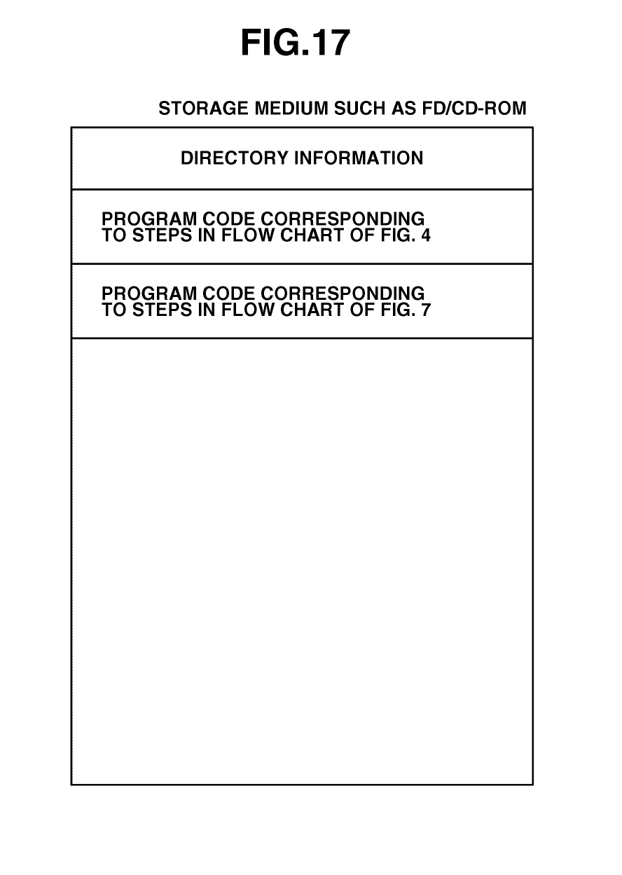

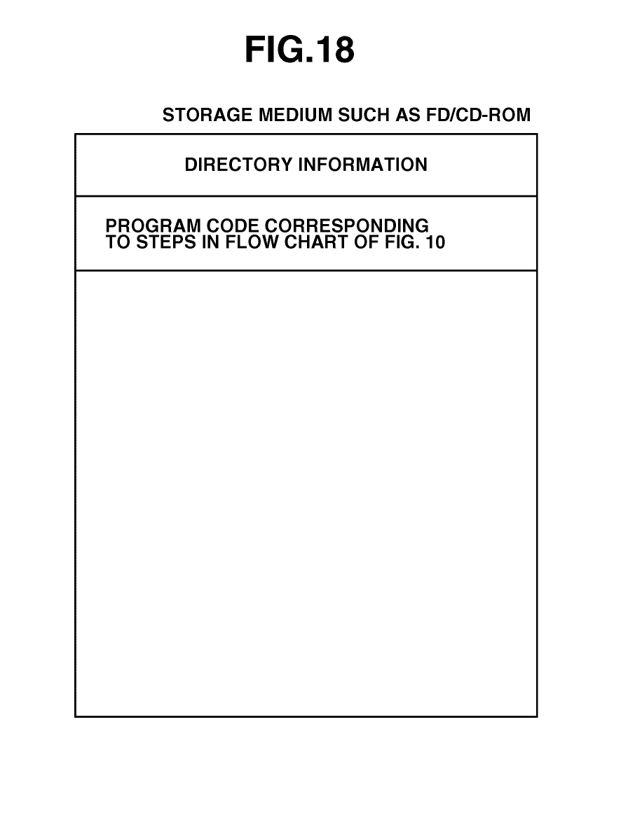

The configuration of a data processing program that can be read by an image forming apparatus and an information processing apparatus according to a fourth exemplary embodiment of the present invention is described with reference to memory maps illustrated in FIG. 17 and FIG. 18.

FIG. 17 illustrates a memory map of a storage medium that stores various data processing programs that can be read by the image forming apparatus 102 according to the present exemplary embodiment of the present invention.

FIG. 18 illustrates a memory map of a storage medium that stores various data processing programs that can be read by an information processing apparatus according to the present exemplary embodiment of the present invention.

Information for managing the programs stored in the storage medium such as version information, and information concerning the creator of a program, and information that depends on an OS of an apparatus that reads the program such as an icon for identifying and displaying the program can be stored in the storage medium.

Data that is subordinate to the various programs is also managed in a directory of the storage medium. In addition, a program for installing the various programs on a computer, and in the case where a program to be installed is compressed, a program for decompressing the compressed program can be stored in the storage medium.

The functions according to the present exemplary embodiments illustrated in FIG. 4, FIG. 7, and FIG. 10 can be implemented by a host computer using a program that is externally installed. In this case, the present invention can be applied to the case where a group of information including a program is supplied to an output device from a storage medium such as a compact disk-read only memory (CD-ROM), a flash memory, and a floppy disk (FD) or from an external storage medium via a network.

The present invention can also be achieved by providing a system or an apparatus with a storage medium storing program code of software implementing the functions of the embodiments and by reading and executing the program code stored in the storage medium with a computer of the system or the apparatus (a CPU or a micro processing unit (MPU)).

In this case, the program code itself which is read from the storage medium implements the functions of the embodiments described above, and accordingly, the storage medium storing the program code constitutes the present invention.

Accordingly, the program can be configured in any form, such as object code, a program executed by an interpreter, and script data supplied to an OS.

As the storage medium for supplying such program code, a floppy disk, a hard disk, an optical disk, a magneto-optical disk, a magnetooptic disk (MO), a CD-ROM, a compact disk recordable (CD-R), a compact disk rewritable (CD-RW), a magnetic tape, a nonvolatile memory card, a ROM, and a digital versatile disk (DVD (DVD-recordable (DVD-R) or DVD-rewritable (DVD-RW)), for example, can be used.

In this case, the program code itself which is read from the storage medium implements the function of the embodiments mentioned above, and accordingly, the storage medium storing the program code constitutes the present invention.

The above program can be supplied by connecting to a web site on the Internet by using a browser of a client computer and by downloading the program from the web site to a storage medium such as a hard disk. In addition, the above program can be supplied by downloading a compressed file that includes an automatic installation function from the web site to a storage medium such as a hard disk. The functions of the above embodiments can be implemented by dividing the program code into a plurality of files and downloading each divided file from different web sites. That is, a World Wide Web (WWW) server and a file transfer protocol (ftp) server for allowing a plurality of users to download the program files for implementing the functional processing configure the present invention.

In addition, the above program can be supplied by distributing a storage medium such as a CD-ROM and the like which stores the program according to the present invention after encrypting the program. The user who is qualified for a prescribed condition is allowed to download key information for decoding the encryption from the web site via the Internet and can execute and install in the computer the encrypted program code by using the key information.

The functions according to the embodiments described above can be implemented not only by executing the program code read by the computer, but also by the processing in which an operating system (OS) or the like carries out a part of or the whole of the actual processing based on an instruction given by the program code.

In another aspect of the embodiment of the present invention, after the program code read from the storage medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-167932 filed Jun. 26, 2007, which is hereby incorporated by reference herein in its entirety.

What is claimed is:

1. An information processing apparatus configured to edit data including an object used for forming an image comprising:
a determination unit configured to determine whether the object can be normally output with a resource used for forming a specific image before forming an image of the object; and
a generation unit configured to generate data that restricts editing of the object that is determined to be normally outputable by the determination unit and generate data that does not restrict the editing of the object that is determined not to be normally outputable by the determination unit.

2. The information processing apparatus according to claim 1, wherein the determination unit determines again whether the object can be normally output with the resource in updating the object.

3. The information processing apparatus according to claim 2, further comprising:
a storage unit configured to store the object; and
an updating unit configured to update the object stored on the storage unit based on a result of re-determination by the determination unit that the object can be normally output.

4. The information processing apparatus according to claim 1, wherein the generation unit determines whether to permit the editing of the object based on authentication information input by a user when the user requests the editing of the object.

5. The information processing apparatus according to claim 1, wherein the generation unit allows a user to insert a comment within the object describing a ground that the determination unit determines that the object cannot be normally output.

6. The information processing apparatus according to claim 1, further comprising a correction candidate output unit configured to output correction candidates used for correcting the object so that the object becomes normally outputable as image information when the determination unit determines that the object cannot be normally output with the resource.

7. The information processing apparatus according to claim 6, wherein the correction candidate output unit outputs animation objects as the correction candidates.

8. The information processing apparatus according to claim 6, wherein the correction candidate output unit outputs three-dimensional objects as the correction candidates.

9. A method for an information processing apparatus configured to edit data including an object used for forming an image, the method comprising:
determining whether the object can be normally output with a resource used for forming a specific image before forming an image of the object; and
generating data that restricts editing of the object determined to be normally outputable and data that does not restrict the editing of the object determined not to be normally outputable.

10. The method according to claim 9, further comprising determining again whether the object can be normally output with the resource in updating the object.

11. The method according to claim 10, further comprising:
storing the object in a storage unit; and
updating the object stored in the storage unit based on a result of re-determination that the object can be normally output.

12. The method according to claim 9, further comprising determining whether to permit the editing of the object based on authentication information input by a user when the user requests the editing of the object.

13. The method according to claim 9, further comprising allowing a user to insert a comment within the object describing a ground for determining that the object cannot not be normally output.

14. The method according to claim 9, further comprising outputting correction candidates used for correcting the object so that the object becomes normally outputable as image information when it is determined that the object cannot be normally output with the resource.

15. The method according to claim 14, further comprising outputting correction candidates as animation objects.

16. The method according to claim 14, further comprising outputting correction candidates as three-dimensional objects.

17. A computer-readable storage medium storing instructions for causing a computer to execute the method according to claim 9.
